(19) United States
(12) Patent Application Publication
(10) Pub. No.: US 2015/0161695 A1
(43) Pub. Date: Jun. 11, 2015

(54) SYSTEMS AND METHODS FOR NORMALIZING AND COMPARATIVELY DISPLAYING DISPARATE SERVICE OFFERINGS

(71) Applicants: Tom Koby, O'Fallon, MO (US); Alan Lerner, Phoenix, AZ (US)

(72) Inventors: Tom Koby, O'Fallon, MO (US); Alan Lerner, Phoenix, AZ (US)

(21) Appl. No.: 14/555,079

(22) Filed: Nov. 26, 2014

Related U.S. Application Data
(63) Continuation-in-part of application No. 14/310,990, filed on Jun. 20, 2014.
(60) Provisional application No. 61/837,731, filed on Jun. 21, 2013.

(51) Int. Cl. G06Q 30/06; G06Q 50/08

(52) U.S. Cl. CPC G06Q 30/0611; G06Q 50/08

(57) ABSTRACT

Systems and methods for providing instant, real-time quotes for mixed product/service solutions, such as home improvement products, and allowing for equal price comparisons and a sales tool for instant budget selection and viewing.

### CROSS REFERENCE TO RELATED APPLICATION(S)

This application is a Continuation-in-Part (CIP) of U.S. Utility patent application Ser. No. 14/310,990 filed Jun. 20, 2014 which in turn claims benefit of U.S. Provisional Patent Application No. 61/837,731 filed Jun. 21, 2013. The entire disclosure of both documents is incorporated herein by reference.

### BACKGROUND

1. Field of the Invention

This disclosure relates to the field of quoting and, specifically to providing comparison quoting for dissimilarly priced-mixed offerings of labor, materials, and/or installation services.

2. Description of the Related Art

Getting quotes and estimates for certain types of products and services is difficult and time-consuming. This is particularly true where products and services are sold together, such as home improvement projects. The difficulty is in part because service providers and customers both suffer from a lack of complete information. Customers do not know provider material or labor costs, and providers do not know the details of the customer project. The bidding/estimate process fills this gap for the supplier, who physically visits the work site to take measurements, ask questions, and gather the information needed for the supplier to complete the bid.

However, this does not solve the information disparity for the customer, who often has only the final bid number, devoid of detail on the calculations that comprise it. This makes comparing that bid with another contractor's bid difficult. Even where the customer has enough detail to compare bids, non-trivial calculations may be necessary to compare the bids on an equal basis. Further, where there are major gaps between two suppliers, the customer lacks information about service quality, which could explain pricing disparities. For example, do bids differ because one provider does better work (and charges more), or is a supplier more expensive because he pays more for materials?

The bidding process presents other difficulties as well. Estimates typically require measurements and different suppliers may measure differently. For example, where a homeowner wishes to have hardwood flooring installed in a kitchen, one supplier may measure to the kick plate of existing counters, whereas another measures to the walls. This adds to the difficulty in comparing bids.

Getting multiple bids also means multiple installers physically visit the location and take measurements, resulting in needless rework and wasted time. Moreover, many providers take the opportunity to engage in high-pressure on-the-spot sales pitches, asking about other bids in an attempt to win the job on the spot before the consumer can think through options, or comparison shop.

Further complicating things, the costs of materials and labor can vary wildly. This is not only because of quality differences, but differences in provider price models. One installer may pay $25.00 per square foot for a material that costs another installer only $19.00. Where these prices are not included in the bid detail, the customer has no way of knowing whether a provider is buying the materials cheaper and pocketing the difference instead of passing the savings on to the customer. Likewise, one provider may appear substantially less expensive because that provider's quote does not include features assumed in another provider's bid. For example, one flooring installer may charge a lower per-square foot rate for labor, but exclude thresholds or cutouts, which are additional charges.

Providers also do not price their services in uniform fashion. For example, some charge a flat per-unit rate inclusive of labor and materials, whereas others break out material separately. For example, one service provider may charge $75 per square foot of countertop installed inclusive of the material cost. Such flat-rate pricing is generally limited to a certain tier or quality of material, limiting the customer's options. However, another installer may charge only $50 per square foot, but require the customer to pay actual costs for material, including waste, which the customer is generally not qualified to estimate.

Further complicating this landscape, material suppliers sometimes sell products only through specific distribution chains, or sign exclusivity agreements limiting availability for their products to certain service providers. For example, the supplier for a particularly fashionable granite countertop pattern may enter into an exclusive deal with one specific home improvement store, by which only subcontractors for the home improvement store can install that specific granite. This makes it virtually impossible for customers to simply pick a material that will work in their homes, and then get a list of installers who can use it. Instead, customers must search a number of stores, or providers, to find a desirable material. Ultimately, consumers are sometimes left to choose between an installer who is more expensive but has the specific material the consumer wants, versus an installer who is cheaper but does not. Faced with the prospect of sitting through hours of measurements and sales pitches, many consumers get only a handful of bids (sometimes only one) before giving up and simply picking the least unappetizing option.

Other common problems complicate bidding even further. For example, laying floor tile on the diagonal is generally more attractive, but also requires more cutting. Providers may charge an additional labor rate on a per-square foot basis for this feature, whereas others simply add a flat service charge. Likewise, some suppliers charge extra for working with multiple materials, or materials that require specialized equipment. Others charge more for special features, like upgraded countertop edging.

Existing bidding software merely assists an individual provider with preparing a bid, but does not provide for apples-to-apples comparisons between providers. This is in part because there is so much variance between material costs, labor costs, business models, and pricing metrics used by contractors and suppliers. Even if the customer is able to select the best bid, there remains the issue of managing contracts, change orders, and invoices, and scheduling delivery and installation, which can take days or weeks (sometimes months), and delivery time is not always precisely known in advance. Providers are generally reluctant to schedule installation until they know materials will be available.

Further, while there exist web sites for rating service providers, such as Angie's List™ they do not allow for side-by-side comparisons of provider quality in the context of a quote or bid for a specific project. These crowd-sourced reviewing sites simply compare quality among providers without reference to the scope and extent of the proposed job. Thus, a user cannot, for example, get a side-by-side comparison quote between two providers in addition to review aggregation to add context to the data. That is, where two providers differ wildly in price for the same job, there is currently no way to assess or determine whether or to what extent that difference may be a function of service quality and/or professionalism.

Although a customer could, at least in theory, do a side-by-side comparison of bids on pencil and paper if the customer had access to all the required information, the practical reality is that the variables and differences in how each provider prices services and materials differ so wildly that the average consumer is unlikely to be able to accurately run all of those calculations to produce a fair comparison. Moreover, the time required for that type of intellectual labor often far exceeds the patience and available free time of the customer. Moreover, this assumes the user has access to all the needed information. If the customer decides to change an aspect of the bid, such as the material, or add a feature, the customer has no way of knowing how that changes the bid estimate other than to go to the provider and ask. Ultimately, it's effectively impossible to compare bids on an apples-to-apples basis in real time. The only way users can compare periods, whether in real time or not, is by going through a human intermediary who acts as the gatekeeper for service provider pricing information.

At the end of the day, it's impossible for the customer to independently get accurate apples-to-apples comparison between two contractors for the same job, and the bidding process generally results in a great deal of lost time and inefficiency, not only for the customer, but also for the installers, who are constantly called out to take redundant measurements or price out projects that go nowhere.

### SUMMARY

The following is a summary of the invention, which should provide to the reader a basic understanding of some aspects of the invention. This summary is not intended to identify critical components of the invention, nor in any way to delineate the scope of the invention. The sole purpose of this summary is to present in simplified language some aspects of the invention as a prelude to the more detailed description presented below.

Because of these and other problems in the art, described herein, among other things, is a method for comparatively displaying quotes comprising: providing a database; providing a quote server communicatively connected to a client device over a network, the quote server comprising a microprocessor and a non-volatile computer-readable medium having computer readable instructions stored thereon, the computer-readable instructions comprising a quote module; storing normalized quote metric data in the database; the quote server receiving from the client device over the network a customer project criteria dataset comprising at least one measurement of a dimension for a home improvement project and an indication of at least one material to be used in a home improvement project, the amount of the material to be used in the home improvement project being based at least in part on the at least one measurement of a dimension; the quote module selecting from the stored normalized quote metric a search result dataset, the selection of the search result database being based at least in part on the received customer project criteria dataset and comprising data indicative of a plurality of service providers, each service provider in the plurality of service providers being associated in the stored normalized quote metric data with the material; for each one of the service providers in the plurality of service providers, the quote module calculating a bid estimate for the service provider to install the material in the home improvement project, the calculated bid estimate being based at least in part on a cost of the material indicated in the stored normalized dataset for the service provider, and the calculated bid estimate being based at least in part on the measurement of a dimension received by the quote server; the quote server transmitting data to the client device, the transmitted data causing to be displayed on the client device, for each one of the service providers in the plurality of service providers, an identification of the service provider indicated in the stored normalized dataset and the calculated bid estimate for the service provider.

In an embodiment of the method, the quote metric data is selected from the group consisting of: material data, feature data, supplier data, service provider data, and group data. In another embodiment of the method, the client device is selected from the group consisting of: a smart phone, a tablet computer, a desktop computer, a laptop computer, an e-reader, and a kiosk.

In another embodiment of the method, the calculated bid estimate comprises a labor cost, a material cost, and a feature cost.

In another embodiment of the method, for each service provider in the plurality of service providers, the selected search result data comprises review and rating data about the service provider.

In another embodiment of the method, the transmitted data to the client device further causes to be displayed on the client device, for each one of the service providers in the plurality of service providers, a visualization of the search result data about the service provider.

Also described herein, among other things, is a system for transmitting service provider quotes comprising: a database stored on a non-volatile computer-readable storage medium, the database comprising normalized quote metric data; a computer server communicating over a network, the server comprising a microprocessor and a non-volatile computer-readable storage medium having stored thereon computer-readable program instructions which, when executed by the microprocessor, cause the microprocessor to cause to be transmitted from the computer server to a client device communicatively connected to the server over the network a service provider dataset comprising a plurality of service provider datasets, the service provider dataset based at least in part upon normalized quote metric data selected from the database by the computer server, and the selected normalized quote metric data being selected at least in part based on customer project criteria data received by the server from the client device over the network.

In an embodiment of the system, at least some of the normalized quote metric data in the database is selected from the group consisting of: material data, feature data, supplier data, service provider data, and group data.

In another embodiment of the system, the client device is selected from the group consisting of: a smart phone, a tablet computer, a desktop computer, a laptop computer, an e-reader, and a kiosk.

In another embodiment of the system, for each service provider dataset in the plurality of service provider datasets, the service provider dataset further comprises a programmatically calculated bid estimate for the service provider to perform a scope of services indicated by the customer project criteria received by the server.

In another embodiment of the system, for each service provider dataset in the plurality of service provider datasets, the service provider dataset further comprises a review and rating data about the service provider.

In another embodiment of the system, the review and rating data about the service provider is based at least in part on reviews and ratings about the service provider previously submitted by customers of the service provider.

Also described herein, among other things, is a kiosk comprising: a kiosk frame; a display; a manual user interface; a client computer comprising a microprocessor and a non-volatile computer-readable memory having stored thereon computer-readable instructions which, when executed by the microprocessor, cause the client computer to: display on the display a graphical user interface comprising a form for submitting customer project criteria data; in response to a user submitting customer project criteria data using the form, transmit the customer project criteria data to a quote server and to request from the quote server one or more estimates for the cost of a service provider to complete the project described by the customer project criteria data; in response to receiving from the quote server the one or more estimates, displaying on the display an identification of the service provider and the amount of the estimate.

### BRIEF DESCRIPTION OF THE DRAWINGS

FIG. 1 depicts a high-level flow chart of an embodiment of the systems and methods.

FIG. 2 depicts a schematic flow chart of an embodiment of the systems and methods.

FIG. 3 depicts a schematic diagram of hardware implementing an embodiment of the systems and methods.

FIG. 4 depicts an alternative schematic diagram of hardware implementing an embodiment of the systems and methods.

FIG. 5 depicts an embodiment of a screen for inputting customer criteria and/or data.

FIG. 6 depicts an embodiment of a screen for comparatively displaying bids or quotes.

FIGS. 7A-7B, 8A-8B, 9-10, 11A-11B, 12A-12B, 13A-13B, 14A-14B, and 15A-15B depict embodiments of screens for providing quote metric data.

FIG. 16 depicts an embodiment of a project space visualization program.

FIG. 17 depicts an embodiment of a project dimension calculator program.

FIG. 18 depicts an embodiment of a provider-customization form, which may also be used to customize a kiosk interface.

FIG. 19 depicts an embodiment of a material tagging program.

### DESCRIPTION OF THE PREFERRED EMBODIMENT(S)

The following detailed description and disclosure illustrates by way of example and not by way of limitation. This description will clearly enable one skilled in the art to make and use the disclosed systems and methods, and describes several embodiments, adaptations, variations, alternatives and uses of the disclosed systems and apparatus. As various changes could be made in the above constructions without departing from the scope of the disclosures, it is intended that all matter contained in the above description or shown in the accompanying drawings shall be interpreted as illustrative and not in a limiting sense.

Throughout this disclosure, the term “computer” generally refers to hardware which generally implements functionality provided by digital computing technology, particularly computing functionality associated with processors and microprocessors. The term “computer” is not intended to be limited to any specific type of computing device, but it is intended to be inclusive of all computational devices including, but not limited to: processing devices, microprocessors, personal computers, desktop computers, laptop computers, workstations, terminals, servers, clients, portable computers, handheld computers, smart phones, tablet computers, mobile devices, e-readers, wearable computers including but not limited to Google® Glass™, server farms, hardware appliances, minicomputers, and mainframe computers.

As used herein, a “computer” is necessarily an abstraction of the functionality provided by a single computer device outfitted with the hardware and accessories typical of computers in a particular role. By way of example and not limitation, the term “computer” in reference to a laptop computer would be understood by one of ordinary skill in the art to include the functionality provided by manually manipulable input devices, such as a mouse, track pad, or stylus, whereas the term “computer” used in reference to an enterprise-class server would be understood by one of ordinary skill in the art to include the functionality provided by redundant systems, such as RAID drives and dual power supplies.

It is also well known to those of ordinary skill in the art that the functionality of a single computer may be distributed across a number of individual machines. This distribution may be functional, as where specific machines perform specific tasks; or balanced, as where each machine is capable of performing most or all functions of any other machine and is assigned tasks based on its available resources at a point in time. Thus, the term “computer” as used herein, can refer to a single, standalone, self-contained device or to a plurality of machines working together or independently, including without limitation: a network server farm, “cloud” computing system, software-as-a-service, or other distributed or collaborative computer networks.

Those of ordinary skill in the art also appreciate that some devices which are not conventionally thought of as “computers” nevertheless exhibit the characteristics of a “computer” in certain contexts. Where such a device is performing the functions of a “computer” as described herein, the term “computer” includes such devices to that extent. Devices of this type include, but are not limited to, network hardware, print servers, file servers, NAS and SAN, load balancers, and any other hardware capable of interacting with the systems and methods described herein in the matter of a conventional “computer.”

Throughout this disclosure, the term “software” generally refers to code objects, program logic, command structures, data structures and definitions, source code, executable binary files, object code, compiled libraries, implementations, algorithms, or any instruction or set of instructions capable of being executed by a computer processor, or capable of being converted into a form capable of being executed by a computer processor, including, without limitation, virtual processors, or by the use of run-time environments or virtual machines. Those of ordinary skill in the art recognize that software can be wired directly onto hardware, including, without limitation, onto a microchip, and still be considered “software” within the meaning of this disclosure. For purposes of this disclosure, software includes, without limitation, instructions stored or storable in any form of memory device, including RAM, ROM, flash memory, BIOS, CMOS, mother and daughter board circuitry, hardware controllers, USB controllers or hosts, peripheral devices and controllers, video cards, audio controllers, network cards, Bluetooth® and other wireless communication devices, virtual memory, storage devices and associated controllers, firmware, and device drivers. The systems and methods described herein are contemplated to use computers and computer software typically stored in a non-transitory computer- or machine-readable media or memory.

Throughout this disclosure, terms used herein to describe or reference media, including, without limitation, terms such as “media,” “storage media,” and “memory,” generally refer to non-transitory computer-readable media, but may also include transitory media such as signals and carrier waves.

Throughout this disclosure, the term “network” generally refers to any data or telecommunications network over which computers communicate with each other. The term “server” generally refers to a computer providing a service over a network, and a “client” generally refers to a computer accessing or using a service provided by a server over a network. Those having ordinary skill in the art will appreciate the terms “server” and “client” may refer to hardware, software, and/or a combination of hardware and software, depending on context. Those having ordinary skill in the art will further appreciate that the terms “server” and “client” may refer to endpoints of a network communication or network connection, including but not necessarily limited to a network socket connection. Those having ordinary skill in the art will further appreciate that a “server” may comprise a plurality of software and/or hardware servers delivering a service or set of services. Those having ordinary skill in the art will further appreciate that the term “host” may, in noun form, refer to an endpoint of a network communication or network, or may, in verb form, refer to a server providing a service over a network, or an access point for a service over a network.

Throughout this disclosure, the terms “web,” “web site,” “web server,” “web client,” and “web browser” generally refer to computers programmed to communicate over a network using the HyperText Transfer Protocol (“HTTP”), and/or similar and/or related protocols including but not limited to HTTP Secure (“HTTPS”) and Secure Hypertext Transfer Protocol (“SHTP”). The term “web server” generally refers to a computer receiving and responding to HTTP requests, and a “web client” generally refers to a computer having a user agent sending and receiving responses to HTTP requests. The user agent is generally web browser software.

Throughout this disclosure, the term “real time” generally refers to software performance and/or response time within operational deadlines that are effectively generally cotemporaneous with a reference event in the ordinary user perception of the passage of time for a particular operational context. Those of ordinary skill in the art understand that “real time” does not necessarily mean a system performs or responds immediately or instantaneously. For example, those having ordinary skill in the art understand that, where the operational context is a graphical user interface, “real time” normally implies a response time of about one second of actual time for at least some manner of response from the system, with milliseconds or microseconds being preferable. However, those having ordinary skill in the art also understand that, under other operational contexts, a system operating in “real time” may exhibit delays longer than one second, such as where network operations are involved which may include multiple devices and/or additional processing on a particular device or between devices, or multiple point-to-point round-trips for data exchange among devices. Those of ordinary skill in the art will further understand the distinction between “real time” performance by a computer system as compared to “real time” performance by a human or plurality of humans. “Real-time” performance by a computer generally implies performance speeds which are actually or practically impossible for a human or plurality of humans to achieve. Even where a human or plurality of humans could eventually produce the same or similar output as a computerized system, the amount of time required would render the output worthless or irrelevant because the time required is longer than how long a consumer of the output would wait for the output or so longer that the output has no commercial value by the time the output is delivered, or, because of the number and/or complexity of the calculations, the commercial value of the output would be exceeded by the cost of producing it.

Throughout this disclosure, the term “material” generally refers to tangible or physical objects or products which are consumed or used for a project. Materials typically are included in the finished project, or otherwise left at the project site, such that the materials are no longer available for use in other projects. By way of example and not limitation, drywall and nails are materials often used in a carpentry project. However, the hammer used to drive the nails, and the fuel consumed to reach the job site, are not generally thought of in the art as “materials.” Also by way of example and not limitation, cabinets, shims, crown molding, and dyed resin are materials often used in kitchen remodeling projects. Surplus molding and/or resin is generally left at the job site for repairs and replacement.

Throughout this disclosure, the term “labor” generally refers to physical or intellectual labor expended to complete the project. Labor is typically the type of work performed for a project for which the person or organization providing the labor expects to be compensated. By way of example and not limitation, contractors often do not charge to scope and bid a project, including taking initial measurements for purposes of bidding, and thus the labor expended in doing so is not generally “labor” as contemplated herein. However, once a contract is awarded, re-measurement often takes place, and that labor is generally included in the cost of the project, and thus is “labor” as contemplated herein. One of ordinary skill in the art will appreciate that labor may, in an embodiment, comprise measuring, manufacturing, fabrication, installation, and/or finishing.

Throughout this disclosure, the term “customer” generally refers to an end-user of the system and methods described herein. It is generally contemplated that a customer is a retail consumer, but it is also specifically contemplated that in certain embodiments, the customer may be a contractor, service provider, or other commercial participant using the system to acquire bid or quote information for purposes of pricing out a project or estimate for a retail consumer.

The explanations of terms provided herein should be understood as limiting, but rather as examples of what certain terms used herein may mean to a person having ordinary skill in the applicable art. A person of ordinary skill in the art may interpret these terms as inherently encompassing and disclosing additional and further meaning not expressly set forth herein.

The systems and methods are described herein generally in reference to construction and home improvement. At a very high level, the systems and methods determine what data is required by service providers (generally referred to herein as “providers”) to provide quotes and bids to customers or potential customers in connection with rendering the services provided by such providers, and collect that data from a plurality of such providers. The data collected is normalized and stored in a database. A quote server receives customers queries, generally submitted by customers using a web site, software application, or kiosk, and the received queries are used to find matching providers in the normalized data in the database. The matches are then comparably displayed to the customer, such that the customer can compare a plurality of quotes on an equal basis, along with aggregated reviews and/or ratings.

Although the present disclosure is generally described with respect to home improvement and residential structures, it is specifically contemplated that the systems and methods may be used in conjunction with other industries and applications, including commercial building improvement, and in non-construction applications, such as but not limited to general services and manufacturing. The present disclosure is suitable for use in connection with any industry or application wherein quotes, bids, or estimates are customarily provided after a requirements- or data-gathering exercise, such as an inspection or customer meeting. This present disclosure is further suitable for use in connection with any industry or application wherein costing or bidding may include material costs, labor costs, and/or installation costs.

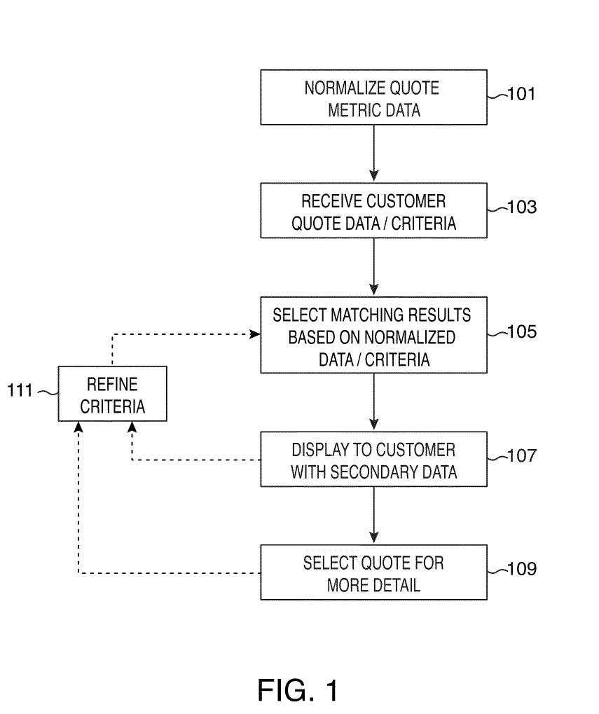

A high-level embodiment of the systems and methods described herein is depicted in FIG. 1. Generally speaking, the systems and methods comprise four elements, which are described in more detail elsewhere herein. First, quote metric data is collected and normalized (101), and generally stored, as normalized, in a database. Second, customer quote generation data and criteria (103) are received from a customer, who generally submits the data using a web site interface, and generally after quote metric data normalization (101). Third, matches are selected from the normalized quote metric data (105), generally based on the received customer quote generation data and criteria. Fourth, one or more matches are caused to be presented or displayed to the customer (107), generally in a comparison format allowing the customer to quickly assess the costs and scope of services offered by each matching bidder, as well as bidder quality. At various steps, the customer may refine search data or criteria (111) and resubmit the refined data or criteria to select (105) revised matches.

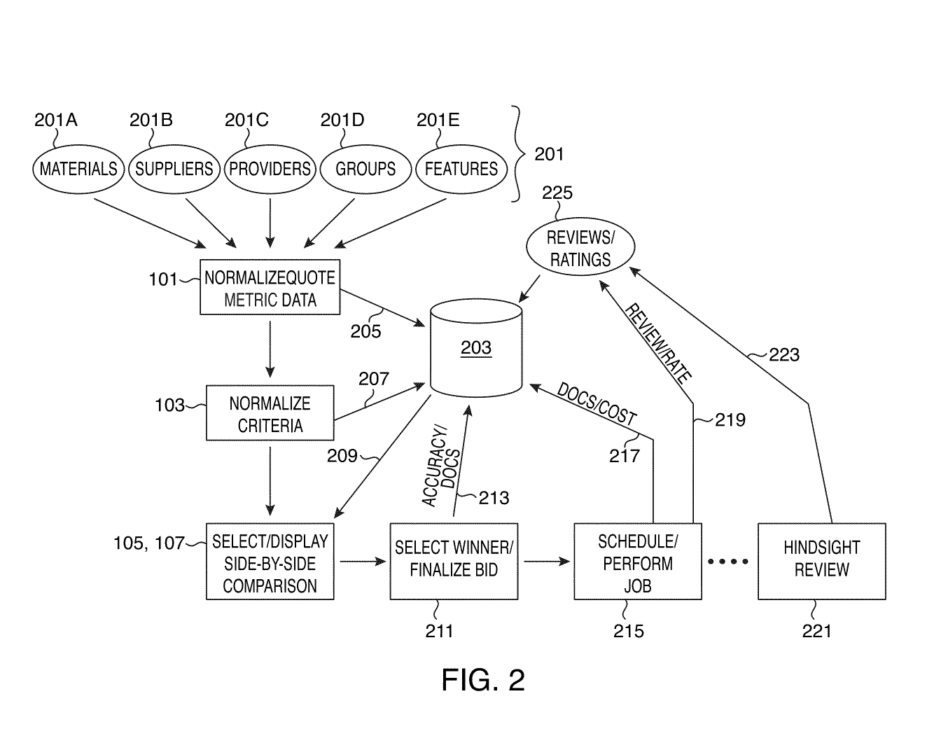

Although the systems and methods can be implemented without the use of computer technology, it is generally contemplated that computer technology will be used, due to the speed and accuracy of computer calculations, and the convenience of mobile computing. FIG. 2 depicts a schematic flow chart of one such computerized embodiment. In the depicted embodiment, quote metric data (201A, 201B, 201C, 201D, 201E) is provided and normalized (101). The depicted quote metric data comprises several categories of data particular to the home improvement industry. It will be understood by one of ordinary skill in the art that, for other industries or applications, other categories of quote metric data will apply.

The depicted quote metric data includes material data (201A). As defined above, materials are generally physical components that become a part of the project (e.g., a building or structure) when installed, or a “fixture” in legal parlance. Materials may be raw, intermediate, or finished goods. For example, for carpentry products, materials may be unsawn boards or dimensional lumber. Likewise, for a solid surface countertop, materials may be raw granite slabs or polished granite. Material data (201A) generally comprises, without limitation, the material type or category, the applicable measurement unit or units for the material, the name or title of a particular material, media files depicting the material, and tags. Generally, tags are searchable descriptive terms associated with the material, usually brief in nature, which can be searched to locate materials having certain characteristics. By way of example and not limitation, for a mottled countertop pattern comprising gold and black inclusions, the tags may comprise “gold”, “black”, and “mottled.”

The depicted quote metric data includes material supplier data (201B). Material suppliers (herein, “suppliers”) are generally entities or individuals whose commercial function in the industry is to supply materials for use in projects. For example, in the depicted embodiment, a supplier may be a lumberyard supplying dimensional lumber (a material) to a carpenter (a provider). Supplier data (201B) generally comprises, without limitation, the supplier name, supplier type, one or more materials supplied by said supplier, the base cost of each such material, the supplier's margin on each such material, and the selling cost of each such material. Base cost may be a wholesale price, or a supplier's actual cost. Alternatively, base cost may comprise a supplier's actual cost plus a margin or markup, or less a discount or markdown. In an embodiment, a separate base cost of each such material may be provided at various quantity tiers or amounts. In an embodiment, material supplier data is associated with one or more materials and/or material data sets in the normalized database (203). In a further embodiment, material supplier data is associated with one or more features and/or feature data sets in the normalized database (203). Such features and feature data are described in more detail elsewhere herein. Supplier type may refer, in an embodiment, to the type of material supplied (e.g., a granite supplier). In an alternative embodiment, supplier type may be the type of supplier enterprise, such as a wholesale or retail supplier.

The depicted quote metric data includes feature data (201E). Features are generally services performed or provided by providers with respect to a given type of project and/or material. Although features are generally elements of the project, in an embodiment, a feature may be a cost item, such as an expense passed along to the consumer. By way of example and not limitation, a feature may be a trip charge as a feature, particularly where a job requires travel beyond a threshold distance defined or provided by the service provider providing the feature. Also by way of example and not limitation, features for countertop installation may comprise putting a particular type of edge (e.g., bullnose or ogee) on the facing edge of the countertop, cutting holes for sinks, faucets, cooktops, power receptacles, or cord grommets. Features may, but are not necessarily, quantifiable. By way of example and not limitation, a feature for backsplash installation may be orienting tile on the diagonal, which is simply a yes/no selection, or opening windows into or out from a structure. Also by way of example and not limitation, a feature may be cutting out a certain number of holes for power receptacles, which is quantifiable. In yet a further non-limiting example, features for flooring may be orienting wood on the diagonal, or cutting around ducting vents. Feature data (201F) generally comprises, without limitation, feature type, feature name and/or description, applicable measurement units, and order of appearance when presented to a user or displayed. Feature type generally comprises the type of calculation performed to produce a quote or bid for a project including the feature. By way of example and not limitation, feature type may comprise a cost-per-unit feature, a flat rate feature, a quantity of features, a quantity of material, or a combination of two or more of these. For quantity of feature and/or material, the feature may be priced based upon whether a certain minimum, maximum, or range of feature and/or material quantities are included. By way of example and not limitation, a feature may have no charge provided the project includes at least 40 square feet of material (i.e. a range of material quantity). Also by way of example and not limitation, a feature may have no charge for up to five such features, and incremental charge per additional units of the feature beyond five (e.g., the first five power outlets cutouts are free, with a $25 per-outlet cutout charge above five).

The depicted quote metric data includes service provider data (201C). Providers are generally entities or individuals whose commercial function in the industry is to assemble, manufacture, and/or install materials and/or features. By way of example and not limitation, a provider may be a flooring installer, a countertop fabricator, a countertop installer, a drywall installer, a carpenter, a stonemason, a landscaper, a woodworker, a cabinet installer, a screen printer, and so forth. In an embodiment, the provider physically visits the project site to perform labor. In an alternative embodiment, the provider may ship a product to a project site, home, place of business, warehouse, or a staging or storage area or facility. Provider data (201C) generally comprises, without limitation, the provider type, name, services offered, base cost/price for each such service, % of price discount or increase for each such service, margin for each such service, selling cost/price for each such service, one or more materials supplied by said supplier, the base cost of each such material, the supplier's margin on each such material, and the selling cost of each such material.

Provider data also generally comprises one or more features the provider can supply, costs for each such feature, and geographic data indicating the service area for the provider. Provider type may refer, in an embodiment, to the type of materials or projects. In an alternative embodiment, provider may comprise a type of business or business relationship. By way of example and not limitation, provider type may be a stocking provider, an exclusive provider, such as for a preferred material supplier, or a general provider.

It should be noted that discount and/or markup amounts may be global for all services, features, and/or materials. By way of example and not limitation, a service provider running a promotional deal may discount all services, features, and/or materials by a fixed amount. Alternatively, service providers may provide discount and/or markup amounts on a per-service, per-feature, and/or per-material basis.

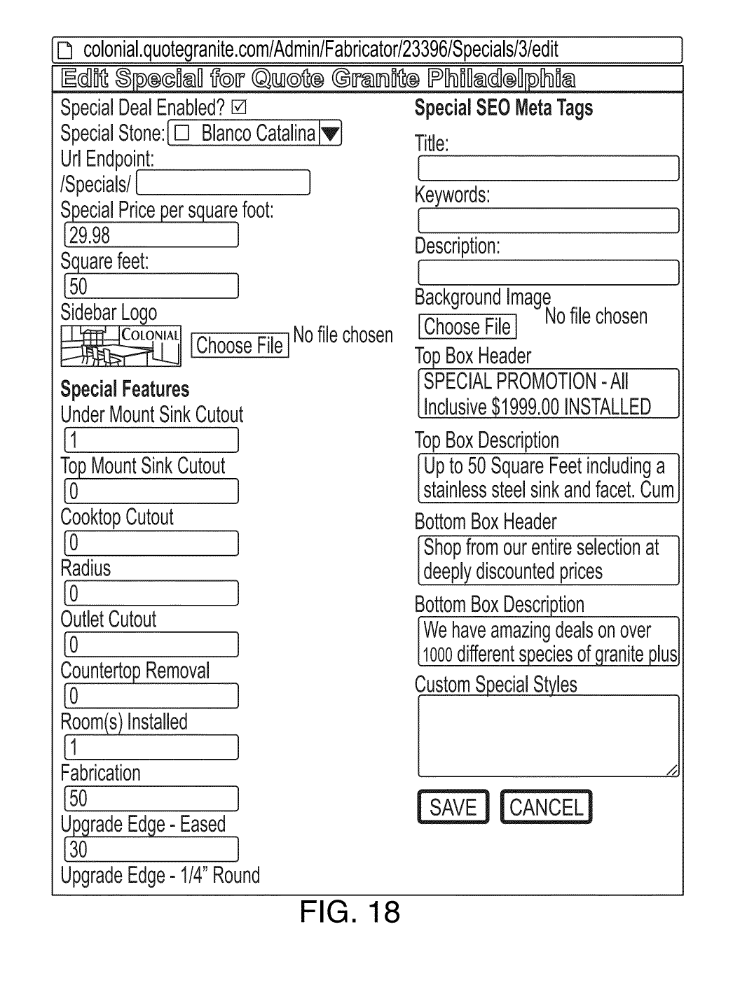

In an embodiment, provider data may further comprise promotional and/or advertising data or information. Such data generally comprises data about specials offered by the provider, such as but not limited to a general discount or special on certain materials, features, or services, as described above. Such data also or alternatively may comprise marketing copy or text describing the promotions or specials. Such data also or alternatively may comprise testimonials, review information, or other content specifically provided by the provider for display to a user or customer in connection with a deal, sale, special, or promotion offered by the provider. Such data may further comprise limiting data. Limiting data may be, for example, data indicative of criteria for a customer to qualify for the discount, or a duration or range of time during which the discount is available or active. An embodiment of a user interface for providing such promotional and/or advertising data is depicted in FIG. 18.

The depicted quote metric data includes group data (201D). Groups are generally sets of providers, including related feature, supplier and material data, organized based upon some commonality. By way of example and not limitation, a group may comprise all hardwood flooring installers serving a given metropolitan area. Alternatively, and also by way of example and not limitation, a group may comprise all installers certified to install a particular type of product. Still further, a group may comprise all subcontractors authorized to perform contracts entered between customers and a big box retail chain. Providers, suppliers, materials, and features will generally aggregate for each particular group. In an embodiment, a group may comprise all subcontractors authorized to perform a particular type of labor or installation, or to install a specific material.

Particular quote metric data (201) may also be sometimes referred to as a “profile.” By way of example and not limitation, quote metric data for a material is sometimes known as a “material profile,” and quote metric data for a service provider is sometimes known as a “service provider profile.” The “profile” for a particular set of quote metric data generally refers to normalized data stored in a database.

This data (201) is generally normalized (101) and transmitted to and/or stored in (205) a database (203). The database will generally be a computerized relational database, such as Oracle®, MySQL™, PostgreSQL™, Microsoft® SQL Server, or functionally similar products. Normalization generally comprises reducing redundancy and duplication and providing uniformity in data quality and format to produce a searchable, canonical dataset. The database is generally communicatively accessible over a network. Normalization may comprise correcting errors, providing default values for missing or omitted data, and following up to clarify unclear, missing, or omitted data. Under some circumstances, however, missing data is expected and anticipated, as one feature of the systems and methods, described elsewhere herein, is that the systems and method can provide comparatively displayed bids on the basis of incomplete information.

It should be recognized that the process of normalization can be quite complex and can involve making data comparable along a number of different criteria. In exemplary embodiments, the normalization methodology may take into account a relatively large number of variables allowing for a true apples-to-apples comparison. For example, in most cases raw materials will be saved based on a raw material cost, and a markup margin of a particular supplier. In order to provide data for a particular customer, the raw material will be priced based on this core pricing, and a selected supplier that can supply the particular provider with the material. Which supplier is selected can be based on fixed relationships or by selecting the lowest cost available supplier for any particular provider. This is an example of a very simple pricing normalization.

The system, however, may be able to take into account a number of other factors. These may be, without limitation, volume, size, distance to job site, type of job, type of customer, materials, and the like. In an embodiment, normalizing may take into account volume discounts. For example, supplier A may be able to provide smaller amounts of material at a lower per foot cost than supplier B, but the opposite is true for larger amounts. This could be, for example, because of the availability of material to the relative suppliers or the size and types of delivery trucks they have available. The system of normalization can account for this by allowing a supplier to enter an indication of any discounts they may provide based on, for example, volume, size, distance to job site, type of job, type of customer, materials, and the like. Similarly, a particular supplier may have an abundance of certain material they are looking to get rid of. In this situation, the supplier may offer a temporary discount to move that material. However, the discount may be limited to orders which total to an amount smaller than the total stock on hand. Thus, the discount may need to be applied dynamically as its availability may be dependent on the order of acceptance of quotes.

For example, purchaser A may have a small order of 10 square feet while purchaser B may have a larger order of 50 square feet. Supplier A may have 50 square feet of a target product in stock that they are willing to provide at a discount. In this case, whichever purchaser requests the quote first, may get the discount price, while the other gets the regular price as there is insufficient stock left at the discount price to meet their need. As the system can normalize dynamically, it may also allow the price to change. For example, if purchaser A requests the quote first, but ends up selecting a different material when they accept their contract, purchaser B's quote may be dynamically updated, or a different quote may be provided when they return to the system, to reflect the changed price.

While the above provides for some examples of specific normalizations, it should be apparent that a whole variety of different factors can be taken into account in normalization. The primary goal of normalization being to reach a final result that is the stated cost for the particulars of the job the purchaser has indicated. This generally requires that disparate information, which is submitted, provided, or otherwise made available by various participants in the market in different formats and using different pricing structures, must be flattened or normalized into a standard format capable of applying programmatic logic to arrive at a true “apples-to-apples” comparison of total installed price.

In an embodiment, normalization includes tiered pricing based upon the amount of material purchased for a particular bid, and/or upon the features and/or quantities of features selected. It is common in various industries for the cost of a project, per unit, to be dependent upon or otherwise related to the amount of material to be used in the project. This may be because the per-unit cost to acquire raw material decreases as the amount of total material increases, due to market forces such as overhead, time, and waste. For example, there is a certain amount of overhead involved in cutting granite from the ground. However, once a granite slab is warehoused, the cost to fabricate the slab into a countertop generally depends primarily on the amount of cutting to be done, and the type of edge to be used. This cost may be far less than the cost of acquiring the slab itself, and the unused portion of the slab will generally go to waste. Thus, it may actually be more cost-efficient to fabricate a larger portion of the slab (i.e., a larger countertop).

Similarly, where multiple slabs are required for a project, they generally must be cut from the same general section of rock, and preferably are adjacent to ensure continuity in color and texture. A single slab without counterparts cut from the same area of the quarry may be much less marketable, and thus there may be cost efficiencies in selling it with counterpart slabs, as opposed to trying to sell the slab on its own. As such, stone suppliers may offer discounts for larger projects that are more likely to use multiple slabs from a given portion of the quarry. Similar considerations apply to other industries and supplies.

Additionally, service providers may price features depending on the amount of material. Where a project exceeds certain material thresholds, the supplier may include certain features without an additional cost, or features that were previously charged a la carte may be included in the price. Again, this makes it difficult for consumers to price compare because the pricing metrics differ, and the consumer generally does not have available information about pricing tiers that the consumer has not reached. This is generally for competitive reasons, as the various commercial actors in the home improvement and construction industry may treat their pricing strategies as trade secrets or simply refuse to share that information. Normalizing the data further comprises

Normalization can also take into account additional materials that may be supplied by the provider as opposed to the supplier. For example, while the supplier may supply raw material such as stone or wood, the provider may act as a supplier for other components such as electrical faceplates, heating vents, sinks, or appliances. In these cases, a provider may wish to provide a quote which is additionally inclusive of these materials to attempt to get additional business.

In an example, if a quote is provided for a countertop having a single sink cutout and six electrical outlets, the provider may choose to provide a quote for the countertop as provided, but then may provide a further quote which includes the costs of the sinks and outlets themselves. This quote may be provided in addition to the competitive quote for the countertop alone or may become the new competitive quote. For example, the returned information could include a comparison of providers for doing only the specific work indicated (provide the countertop) along with a competitive quote for doing additional work that the purchaser may not have contemplated as necessary or desirable. In this way, a supplier may be able to upsell a purchaser by having them buy additional components from that supplier as part of the work, but that upsell may actually save the purchaser money in the long run because those were things that they may have needed anyway and didn't realize could be provided by the provider at less cost (or even at all).

It should be apparent from the above that normalization can include some subjective determinations of what is needed and that the various quotes can be provided using a variety of complex logic and selected criteria provided by all entities involved with the system. The primary goal of normalization is not that each supplier is forced to provide the same type of information or pricing structure, it is so that the estimates which are in the end presented, present the actual estimate for the specific project being requested. In this way a customer can compare bids for their specific entered requirements. Further, because the system may, in an embodiment, allow for a breakdown of how the quote is generated to also be displayed, the user can be aware of what they could potentially alter in their request and still have at least some of the estimates still be valid. This can result in their ability to actually alter the scope of the project to make their cost and perceived benefit as balanced as possible.

Next, a customer seeking bids or estimates for a project supplies (103) customer quote data and/or criteria. Although this generally occurs after normalization, in an embodiment, data may be normalized (101) after the customer supplies (103) this data. Customer quote data and quote criteria may overlap, but may also comprise different sets of data. Customer quote data is generally data providers collect during a site visit to develop a quote, such as dimensions and features the customer wants or needs. Customer quote criteria are other data provided by the customer which may not necessarily be required to produce a quote, but may impact the bid amount or matches found. Such criteria may be subjective criteria, such as requiring certain colors of tile, or only providers who have at least 10 ratings in the system, or only providers whose average rating is above some minimum threshold, or only those providers whose estimates fall within a given dollar amount range.

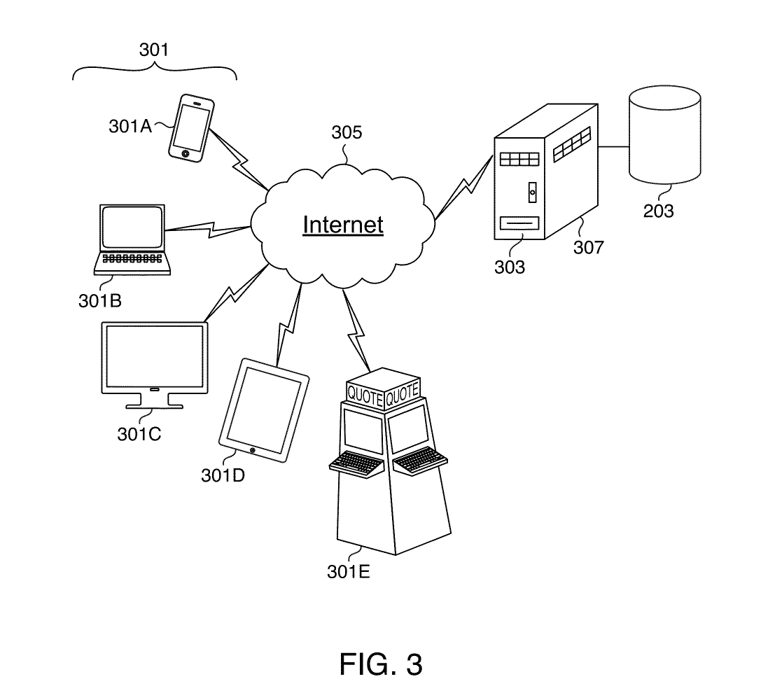

Customer quote data and criteria are generally provided by the customer manually inputting such data. In a simple embodiment, this may be by use of a hand-written form, but in the preferred embodiment, an electronic form is used. Such a form may be an interactive kiosk, a web site form, or an application submitting the data to a server over a network. Such an embodiment is depicted in FIG. 3. In the depicted embodiment of FIG. 3, the customer uses a client device (301) such as a smart phone (301A), laptop computer (301B), desktop computer (301C), tablet device (301D), kiosk (301E), or e-reader (not depicted), to input customer quote data and criteria. The data is received by a quote or bid server (303) over a network connection (305), said network generally comprising the Internet.

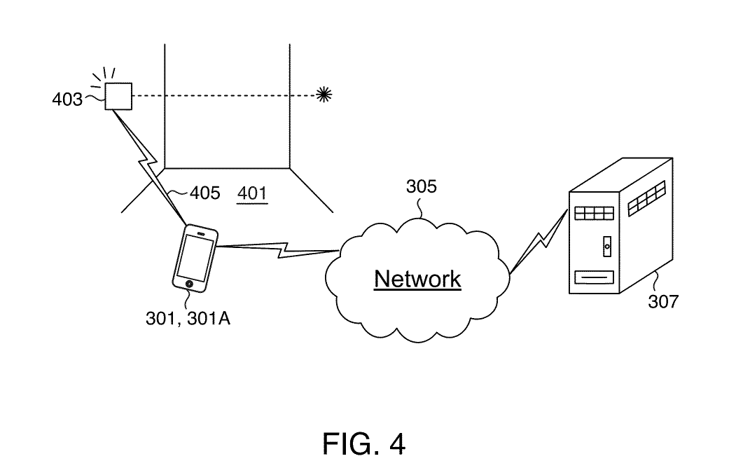

For improved accuracy and uniformity, the data may alternatively be provided using measurements from a measuring device. Such measurements may be wirelessly transmitted, as in the depicted embodiment of FIG. 4. Devices (403) are known in the art which can provide precise measurements using various technologies, such as lasers. It is specifically contemplated that such a device (403) could directly or indirectly provide measurement or other data. By way of example and not limitation, in the depicted embodiment of FIG. 4, a measuring device (403) placed in the work area (401) is used to measure a dimension of the area (401). The device is communicatively connected to a network-enabled device (301), such as a smart phone (301A), which is in turn communicatively connected to the bid server (303) over a network (305). Thus, the measurements taken by the measuring device (403) can be transmitted (405) to the smart phone (301A), which may in turn transmit the measurements to the bid server (303). This technique reduces human error and increases speed and efficiency.

In an alternative embodiment, the measuring device (403) may itself be communicatively connected to the bid/quote server (303), and may not require the use of an intervening network-enabled device (301). Similarly, in another alternative embodiment, the network-enabled device (301) may itself perform the measuring, such as by use of additional hardware or an inherent feature of the device (301), and thus may be able to perform the measurement without the use of an additional measuring device (403), and directly communicate the measurements to the bid server (303).

The customer criteria (103) are generally used to search the normalized data (101) for matching results. Where normalized data (101) has been stored (205) in a database (203), the database (203) is searched. In the system depicted in FIG. 3, a bid server (303) receives the customer criteria/data (103) over a network (305) and queries the database (203) for results based at least in part on the customer criteria/data (103). It will sometimes happen that the customer has not provided complete information. In such circumstances, the server (303) generally will search the normalized data (101) for any results that can be returned based on the data/criteria provided.

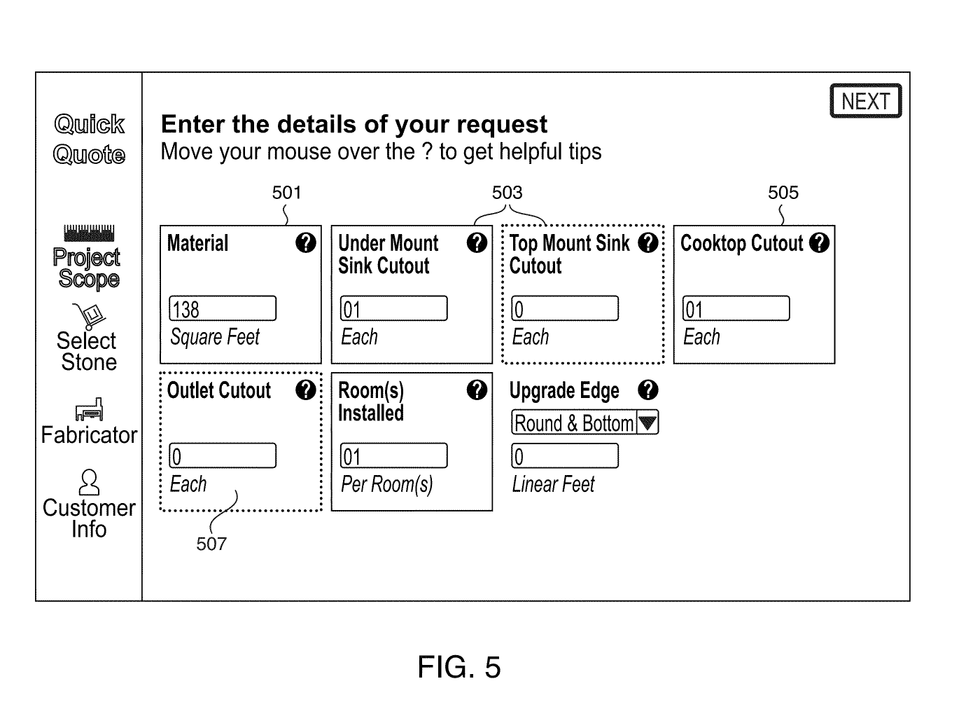

An embodiment of a form is depicted in FIG. 5. In the depicted embodiment, the form requests information about, among other things, the dimensions of the countertop (501), the number of sinks (503) and/or range cutouts (505), and the number of electrical outlets (507). If the customer provides only the dimensions of the countertop. The server (303) will then query the database (203) for any providers whose bid model is capable of returning a bid with that little information. For example, service providers whose pricing includes a sink or range cutoff may be able to provide an estimate, even if the user omits the number of sink or cooktop cutouts required.

In an embodiment, the user is presented with an indication of how many additional bids the user would receive if additional information or broader terms were provided. By way of example and not limitation, if the user provides limited information, such as square footage alone, and receives only one bid, but there are nine more fabricators who could provide bids if the number of sink cutouts were known, a message or indication will be displayed or conveyed to the user indicating that nine more bids will be provided if the user fills in the number of sink cutouts needed. In a still further embodiment, an input form for providing that number is provided with such indication, allowing the user to immediately supply the missing information without having to navigate to the input form.

Similarly to the ability for the system to indicate the availability of additional bids if additional criteria are provided, the system may also be able to indicate the availability of bids for slightly altered projects. For example, if the user generally selected a “red” “silver” and “marbled” granite for a countertop, but had selected a particular material with few suppliers, the system can indicate that a number of additional bids can be received if the user selects a different “red” “silver” and “marbled” granite that has many more suppliers. The system could also indicate that certain other options are available that may be more desirable. For example, if a customer's square footage order is just under a supplier's minimum for preferred pricing, the system may indicate that ordering a large amount of material may actually make the end project comparatively (or absolutely) less expensive. This can be a valuable piece of information depending on the nature of the project and, unlike in prior art systems, allows the consumer to benefit from, or have access to, estimates or other conclusions based upon information which consumer does not have access to. This feature mitigates the problem of data asymmetry as between commercial enterprises and consumers.

For example, a customer may determine the square footage of a flooring project, but exclude the floor area of a closet to save money. However, because of and discount not known or made available to the customer, the project without the closet may actually be more expensive than if the closet area was included. An example of this can often occur where a provider will supply a more expensive raw material at a discount because it is easier to install. For example, the provider may offer the same flat rate labor cost to install either a standard or a premium tile. However, since the premium tile is actually easier to install (and installs quicker), the provider may prefer to work with the premium tile and be willing to provide the premium tile at little or no markup due time savings in labor, or reduced wear on other equipment. In such circumstances, the supplier may prefer to install premium tile without a substantial markup over installing standard tile with a markup. Thus, where a customer has selected a particular material, but a “better” grade of product (or an alternative product in a similar grade) is available with little or no price difference, the system may indicate to the customer that competitive bids are available for such “improved” materials, which can be compared directly to the bids they already have displayed, or can be competitively displayed against each other.

The above illustrates a further example where disparate bids can be displayed and compared. While this system generally presumes that the user has a fixed material interest because that is often the most personal selection, this may not be the case in all circumstances and it should be recognized that the system can take any variable to be more important than others and can allow the customer to customize the bid they see based on what is important to them. Thus, in a first instance the customer can get competitive bids for supplying the same product. In a second instance, the user can get competitive bids where the product is allowed to change, but the price stays fixed. These instances can also be combined in a serial fashion. Thus, for example, the customer can initially provide a set of features and a material they desire. They can then select a “best” bid for this specific criteria. They could next tell the system to hold the price of that bid, and to give them any alternative bids for the same dimensions at that price. This could allow the system to select alternative materials and layouts that match the price, but may in the end be more attractive to the customer.

The idea of this serial bid system is best illustrated by example, the customer selects a first material and a first feature set, and then selects the best bid for their provided dimensions which is $5000. What they then instruct the system to do is to provide all bids for $5000 for their provided dimensions (but allowing the feature set and material to not be the selected first options). What may happen is that a “better” material is available at that same cost, so long as they reduce the features slightly. This can allow the customer to consider options they may have not known were available and allow them to make a better purchasing decision.

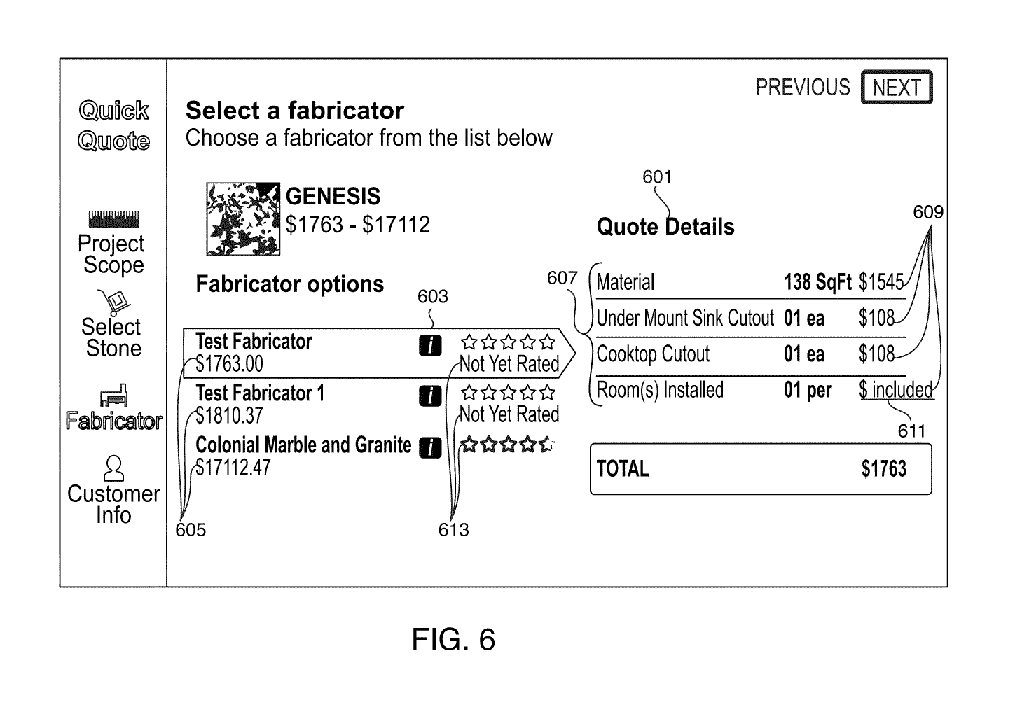

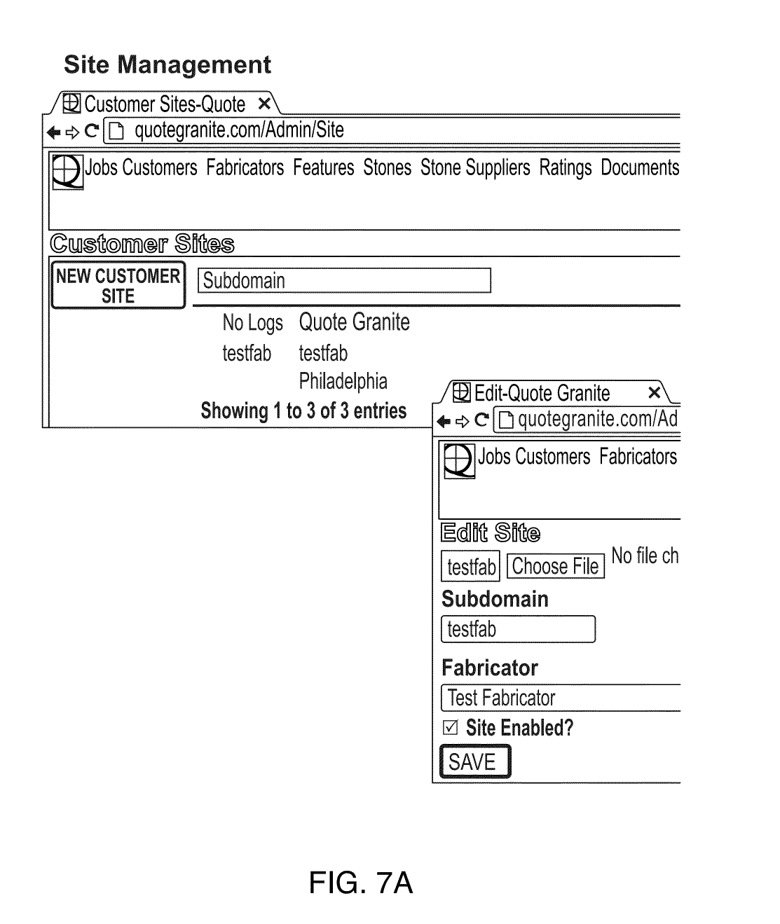

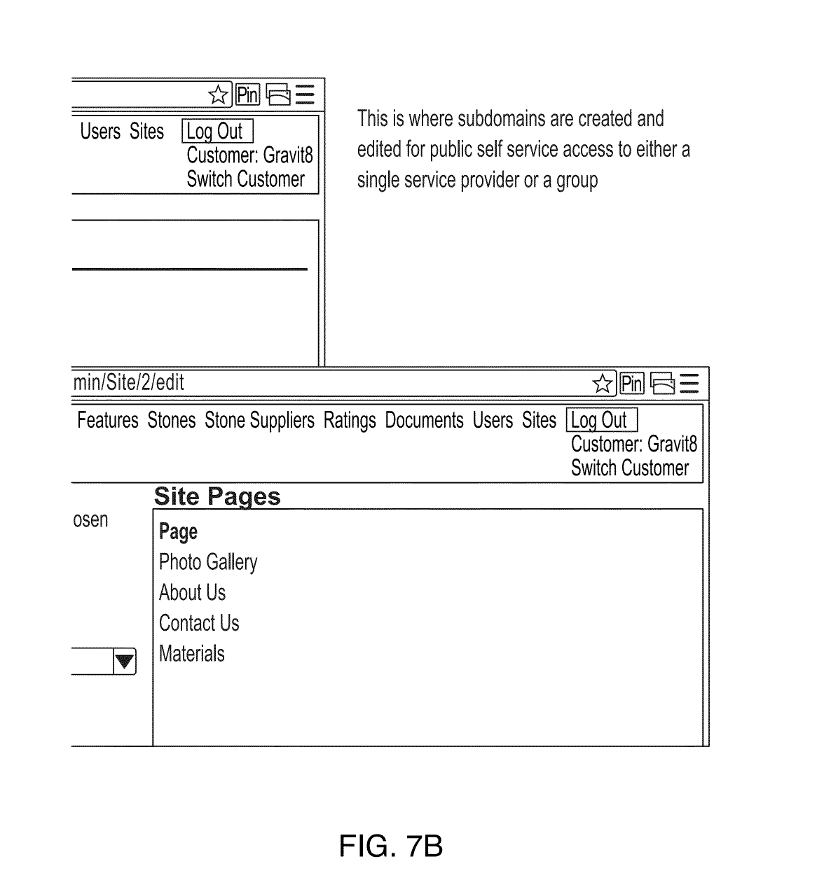

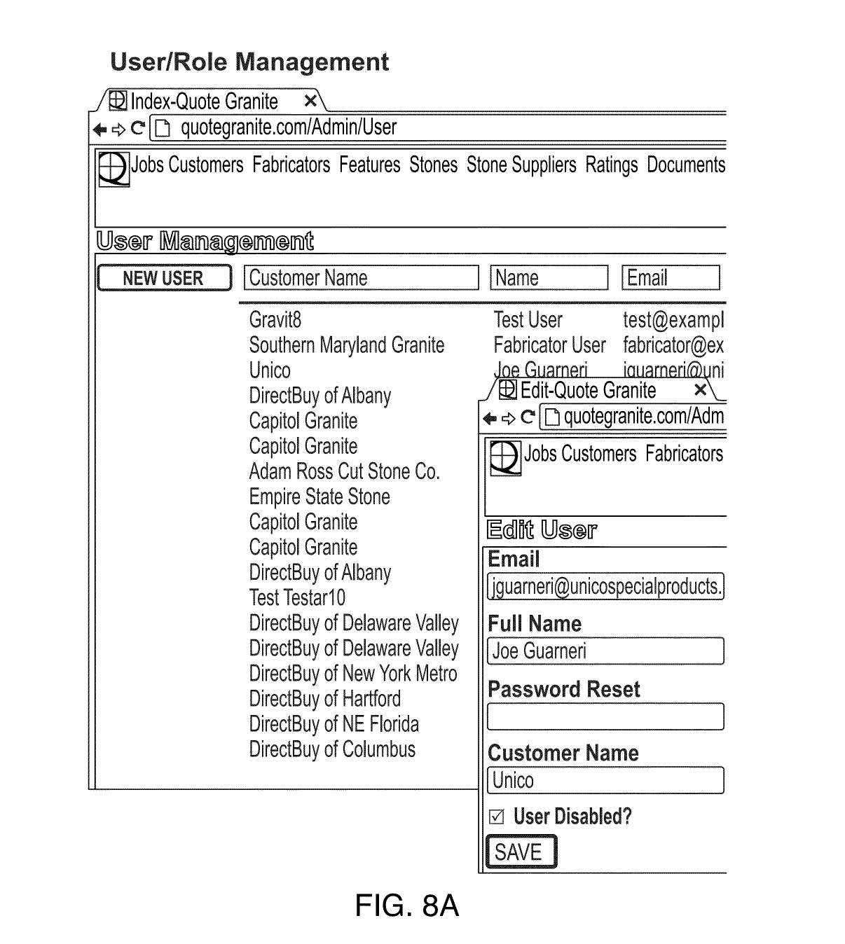

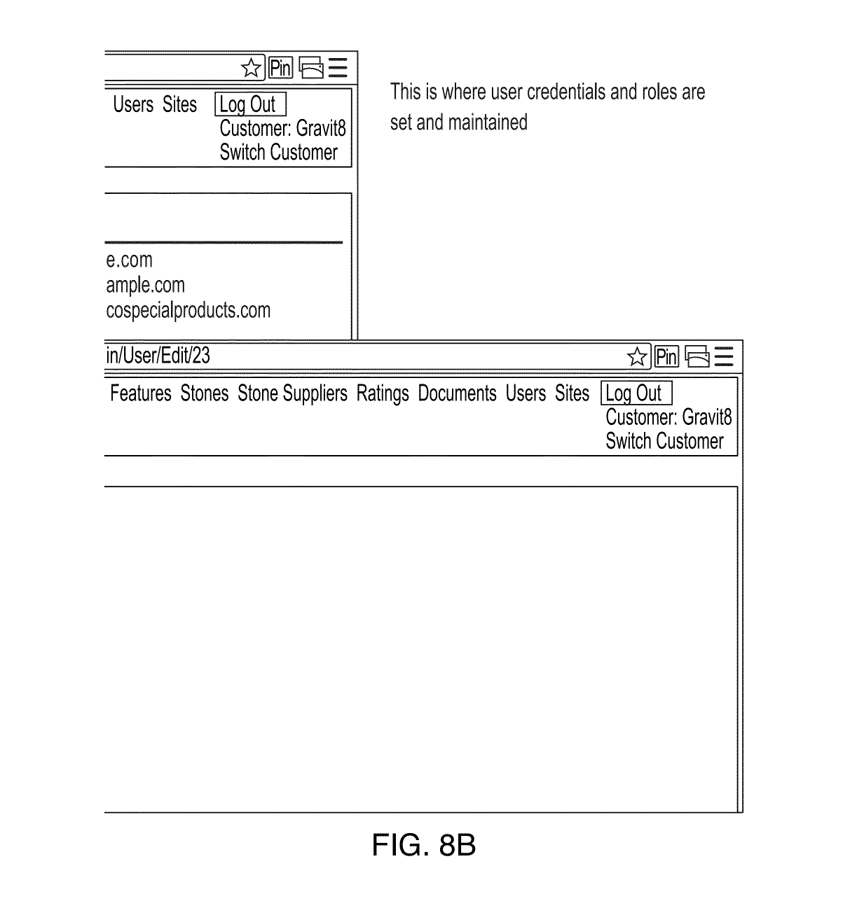

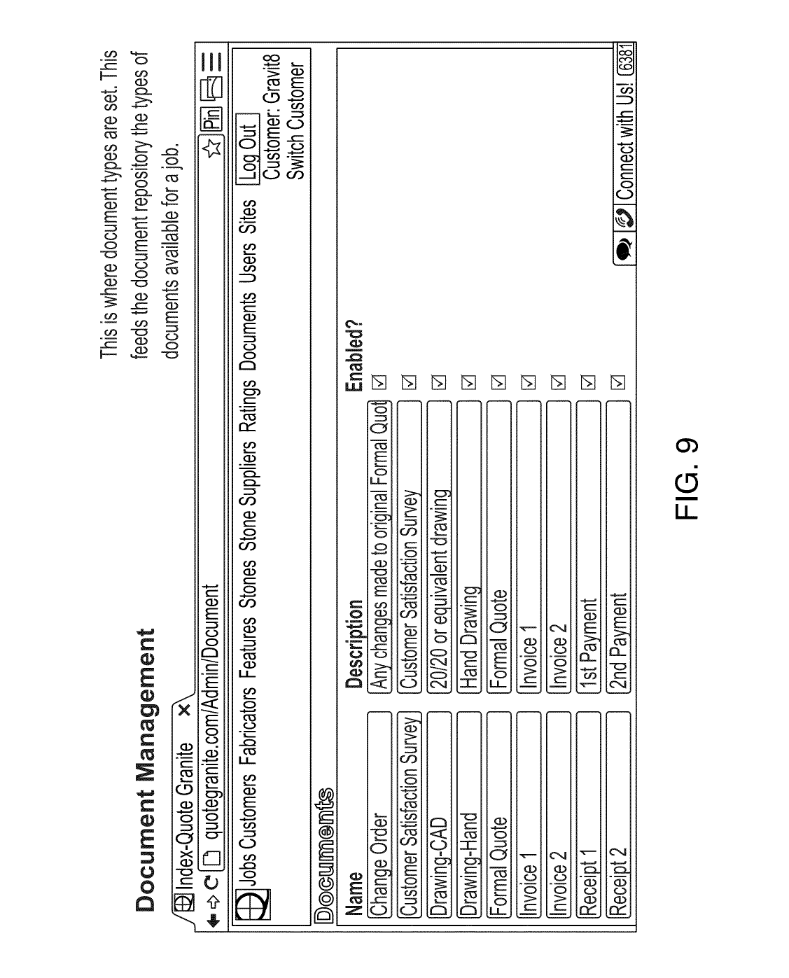

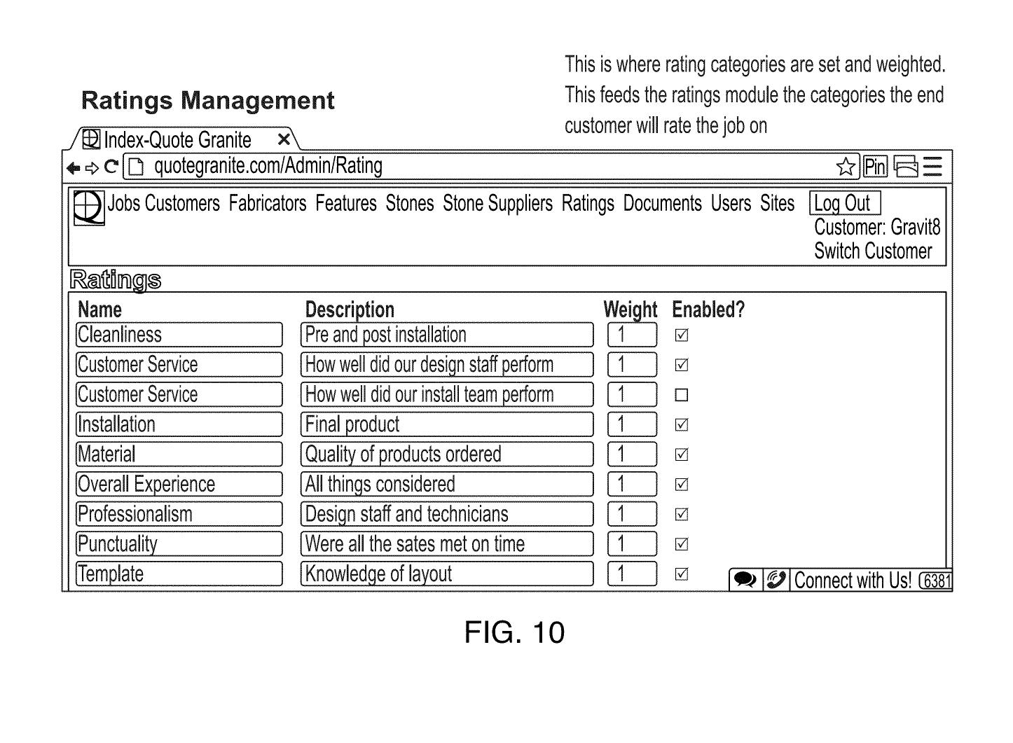

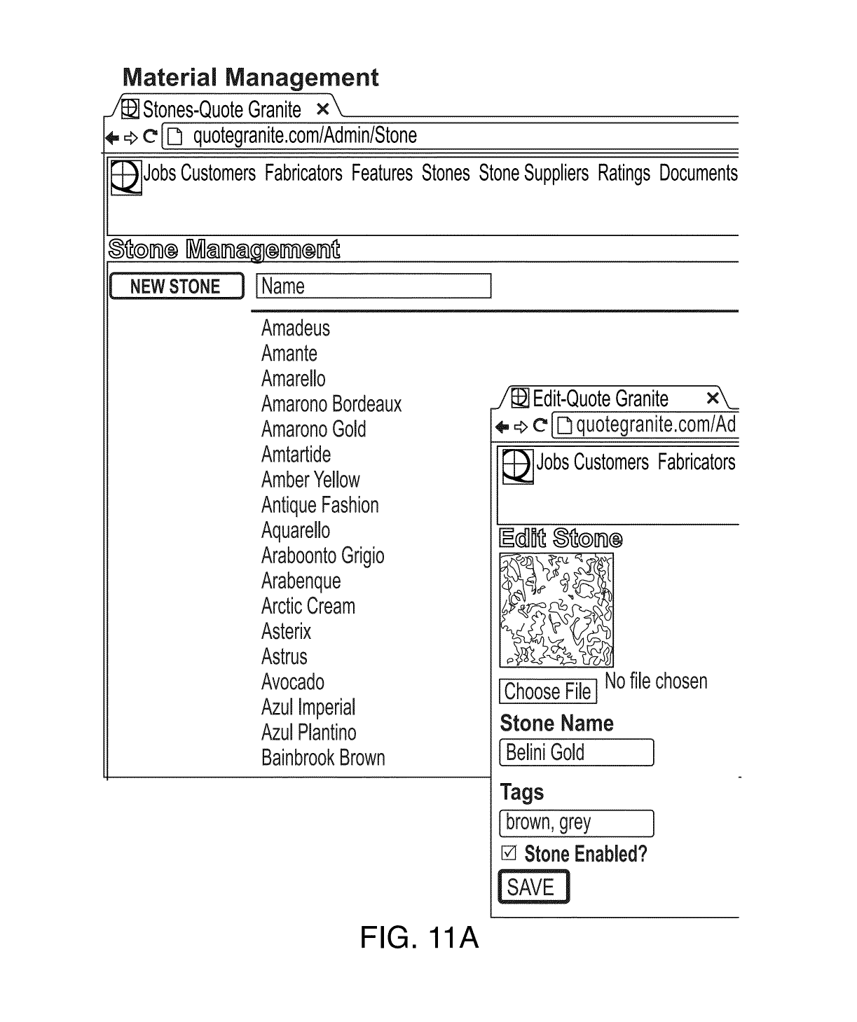

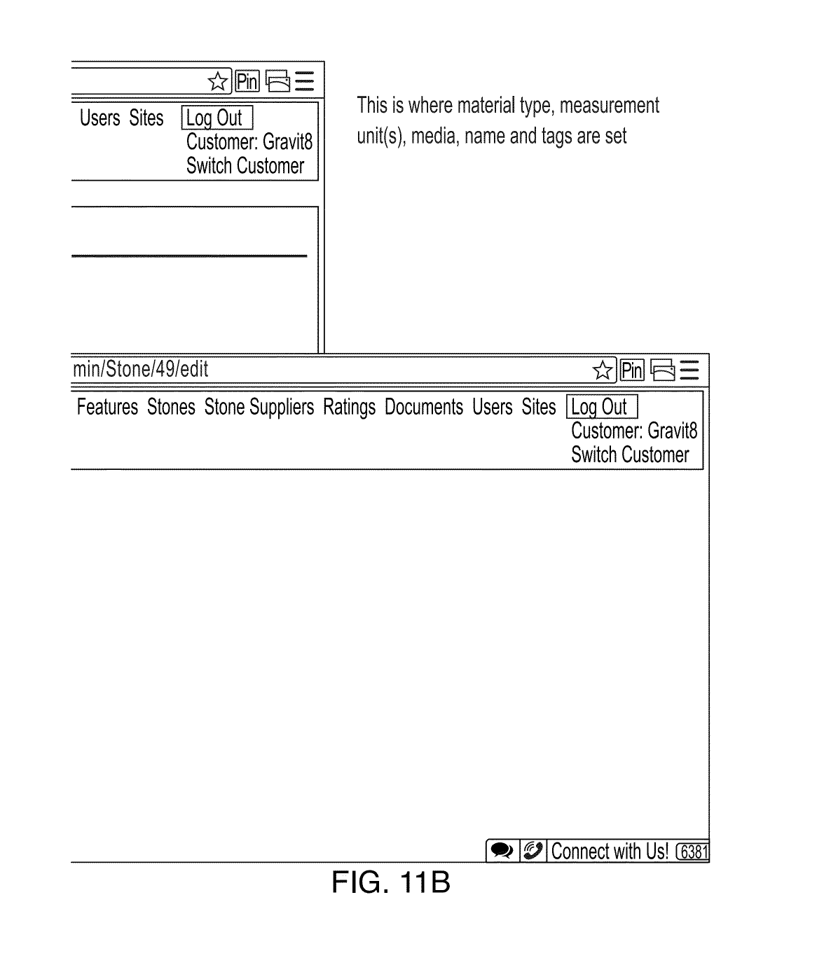

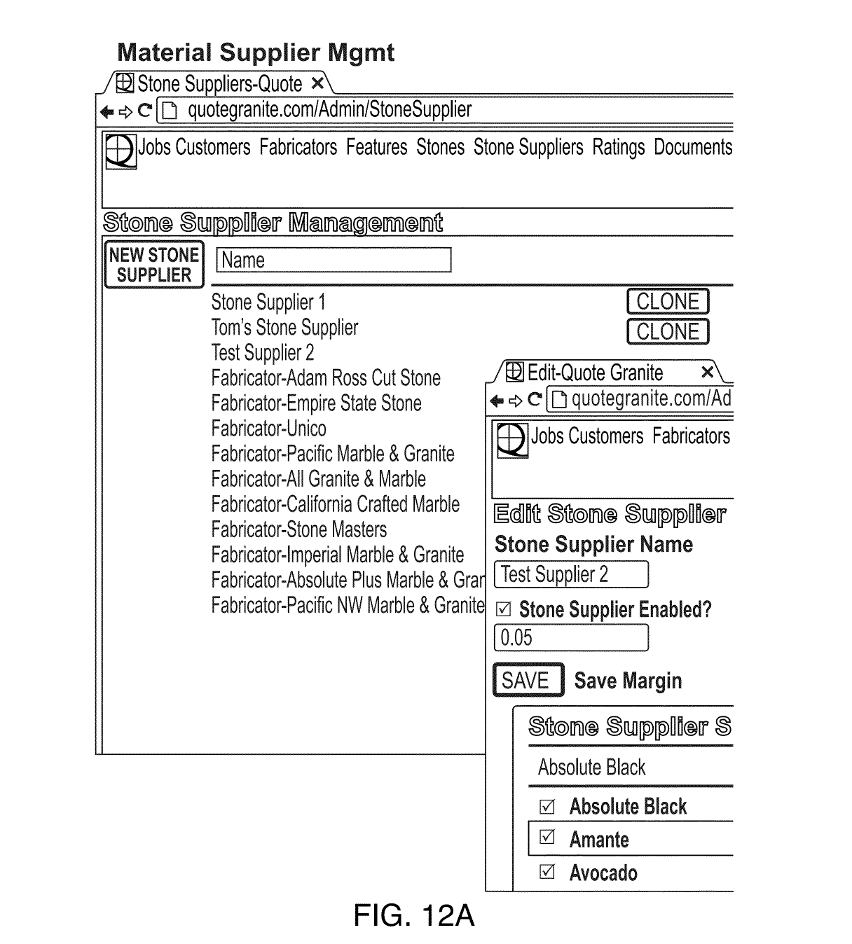

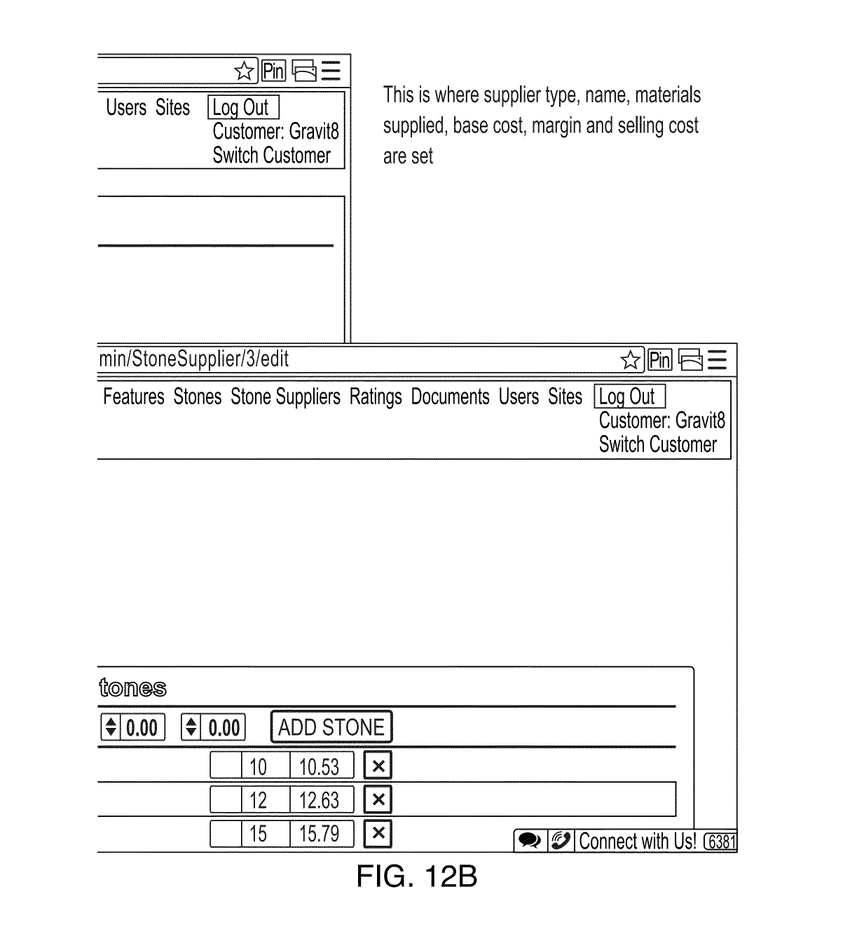

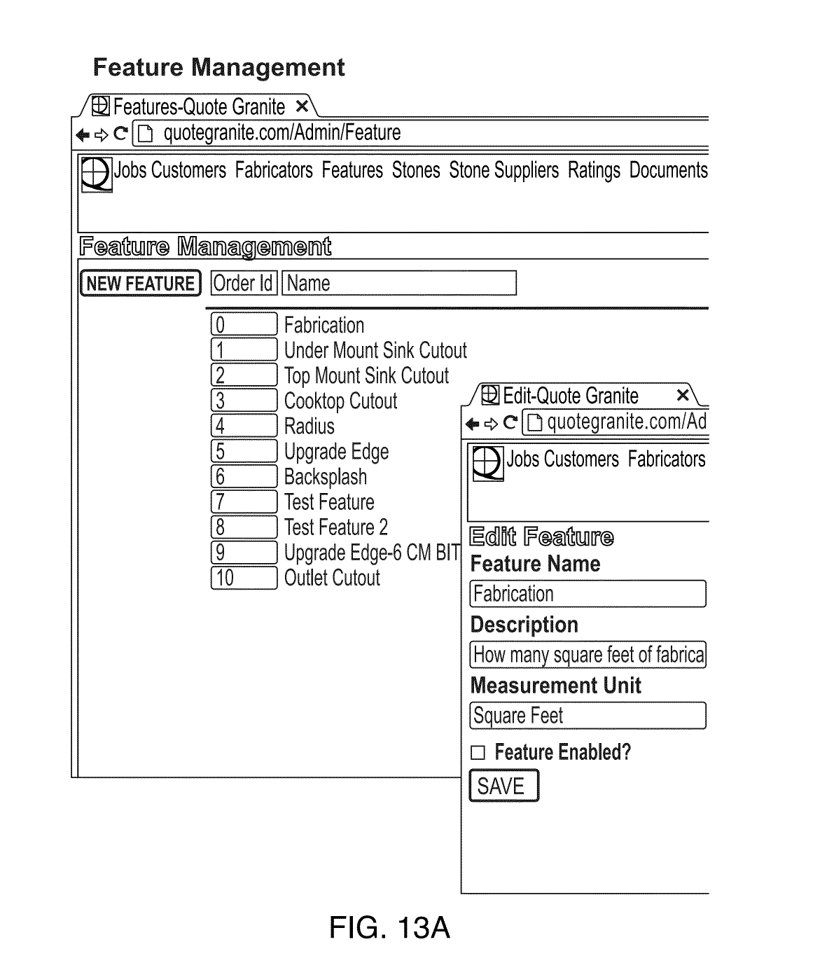

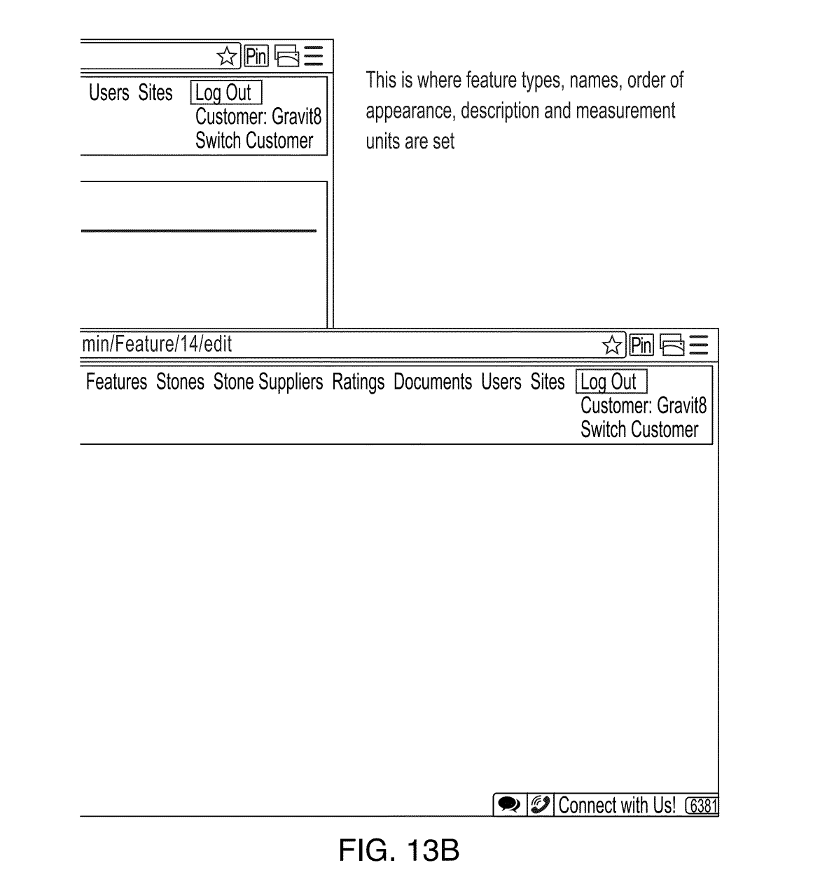

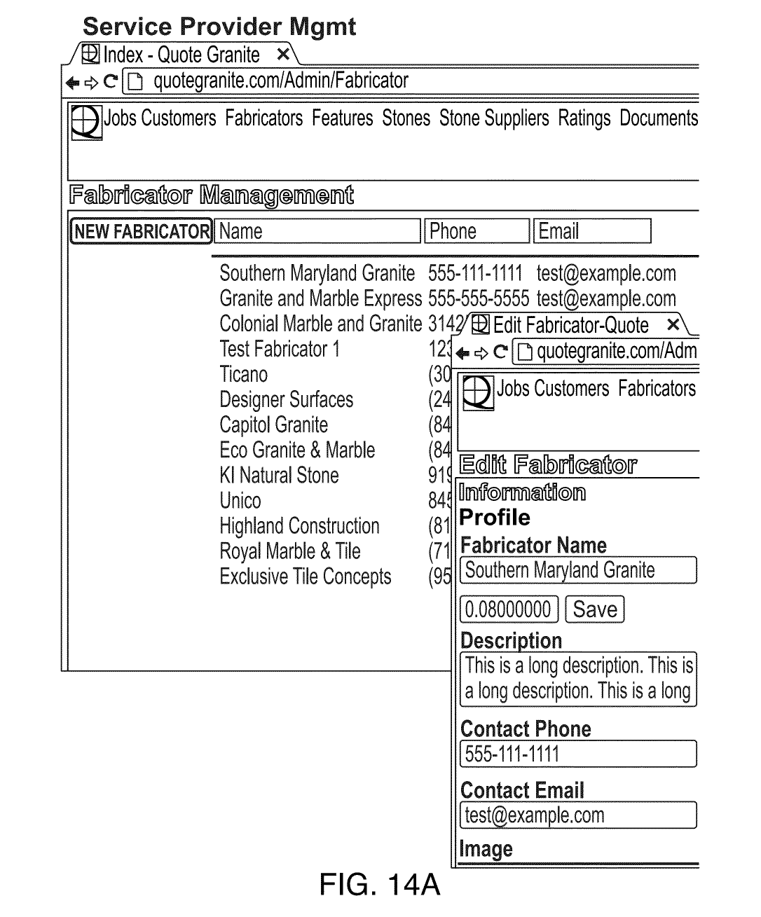

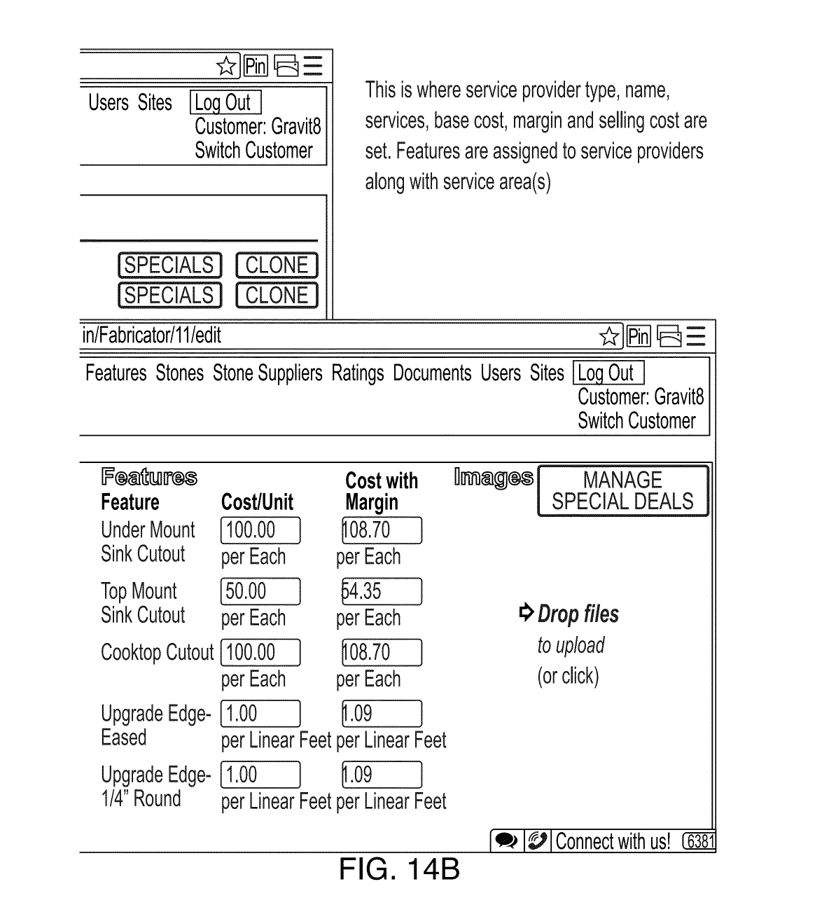

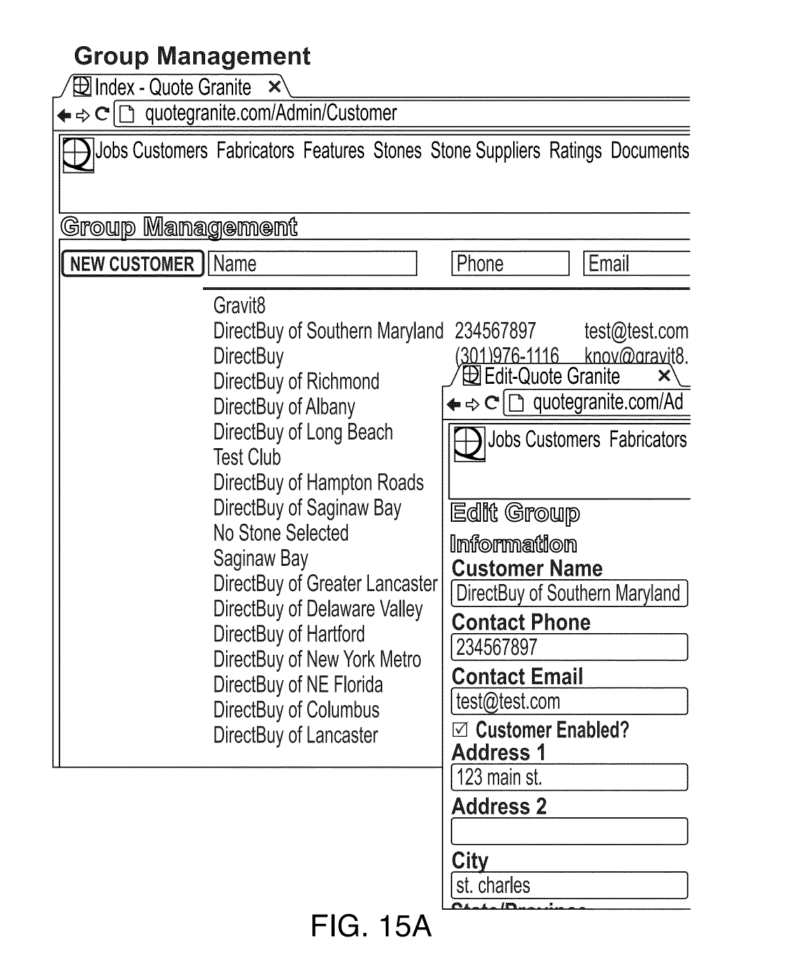

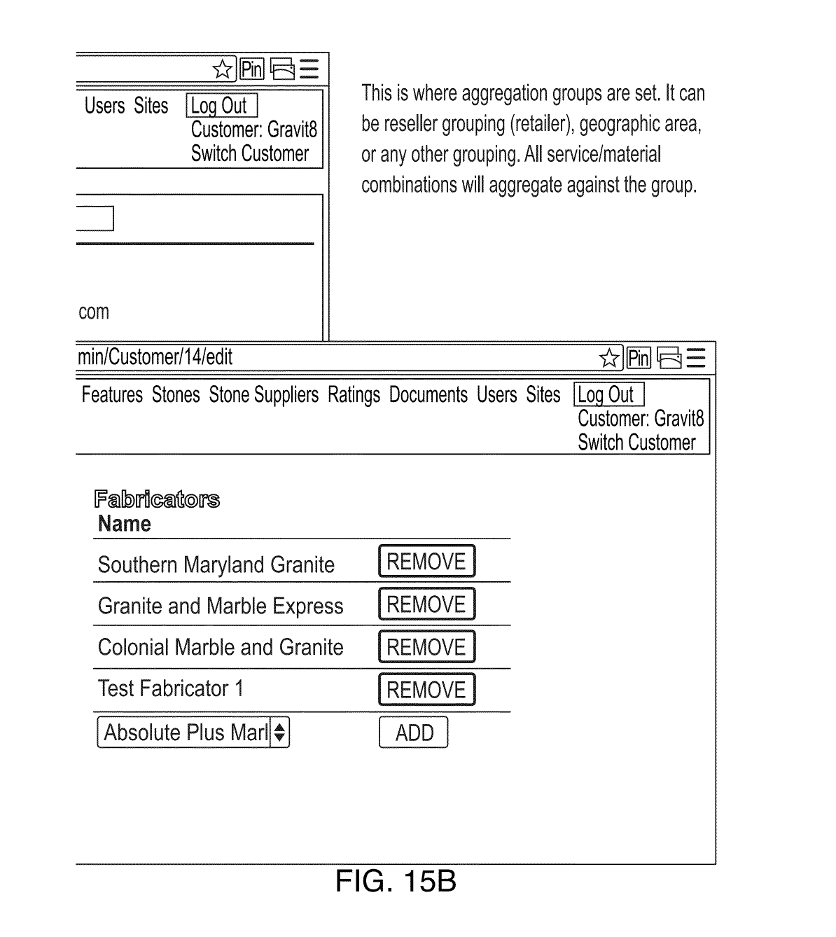

In the depicted embodiment of FIG. 3, the quote/bid server (303) receives matching results (209) from the database (203) and causes them to be comparatively displayed (107) to the user. This display is typically on a user client device (301) such as by the server (303) transmitting an indication of the data or information to be displayed to the user over the network (305). The precise content and arrangement of such display will vary with changing aesthetic tastes and evolving design principles, but generally the display will indicate the overall estimated cost (605) for each provider based upon the quote criteria and/or data supplied by the customer. An exemplary embodiment of such a display in depicted in FIG. 6. Generally, the display comprises details (601) for a selected quote (603), which details include a breakdown (607) of the features provided by the provider and the cost (609) of such features. If a given feature is included in the price, this may also be indicated (611).

Quotes are generally provided in real-time and may require calculations to generate the final quote. These calculations may differ from one provider to another but will generally be based at least in part on data provided by providers and/or normalized data. By way of example and not limitation, Provider A charges $100 per square foot including material, one undermount sink cutout, and one cooktop cutout, and charges $50 per outlet cutout. Demolition and removal of existing countertop is included. Provider B charges $50 per square foot but materials are extra at cost, sinks and cooktops are $250 apiece, and outlets are $100 apiece. Demolition and removal of existing countertop is $100. Provider C charges $3,500 for a complete countertop demolition and replacement including all features requested, provided the customer orders a product that Provider C carries. The user requests bids for a countertop material pattern known as Blue Pearl, with one sink, no cooktop, demolition, and 6 power outlets. The user provides that the total counter space is 44 square feet.

In this illustrative example, the server (303) and/or database (203) perform several calculations. For Provider A, the square footage is calculated as $4400, inclusive of a sink and demolition, plus $300 for power outlets, for a total of $4,700. For Provider B, the square footage is calculated as $2,200, plus $250 for a sink, $100 for demolition, and $600 for outlets, and Provider B buys Blue Pearl for $35 per square foot, for a total of $4,690. For Provider C, the cost is simply $3,500, except that Blue Pearl is not among the materials that Provider C carries, so no bid is calculated or shown for Provider C, as Provider C does not match the customer data or criteria. As described elsewhere herein, an indication may be displayed to the user indicating that if the user selects additional materials, such as material provided by Provider C's supplier, an additional quote will be available. The user may also be presented with the option to include such additional materials (without having to go back and manually select them) in the search criteria so that Provider C's bid may be included.

In this illustrative example, the two bids from Provider A and Provider B are comparatively displayed or caused to be comparatively displayed to the user by transmitting information indicative of the information to be displayed back to the user over the network. As described elsewhere herein, the information is typically displayed on a client device in an appropriate manner for the size, shape, dimensions, and resolution of such device. The user is thus able to understand the components of each bid and to alter the bid criteria to taste. For example, Provider A includes a cooktop in the price, but the user doesn't have a cooktop. For about the same price as Provider B, Provider A actually provides more total features. Thus, the customer is comparing the two providers, who price and structure their goods and services on unequal terms, in an equal “apples-to-apples” manner so that the customer can tell exactly what services/features are included in the price, and which are not.

In a further embodiment, a bid or quote may be modified to include information not requested by the user to ensure an apples-to-apples, or equal comparison. A warning or indication may be provided to the user indicating this change. In the above illustrative example, although the bids might be perceived as “equal” to the extent they are both bids for the scope of the work requested by the user, the scope of services included in the prices is not actually the same because Provider A's price assumes a cooktop cutout (which the user does not need) but Provider B's does not. In an embodiment, an indication may be provided to the user that Provider A's scope of services includes features not needed or requested by the user. In another embodiment, the quote for Provider B may be modified to include a cooktop cutout so that the quotes provided are not only for the same project (user's countertop) but for the same scope of services/features.

An important consideration of the above quote comparison is how it serves to solve an existing problem in industry. Effectively, with regards to any kind of custom work, the customer has information that they provide as part of the bid (e.g. dimensions, preferred materials, preferred features, etc.) but they also have information they may not share. This information may be that the consumer has inflated the square footage to account for waste, has included or excluded certain work areas in the dimensions provided (e.g., area under countertops, area in closets, foyers, landings, stairs, etc.), that the dimensions provided could be slightly bigger or smaller, that the customer is open to alternative materials, that the customer desires more (or fewer) features depending on price, or that the customer is open to alternatives which the customer has discarded based on false assumptions (e.g., that the customer cannot afford those alternatives). This non-sharing may be because the customer doesn't want a provider to attempt to upsell, or because the customer simply doesn't know or understand what other options are or could be available. At the same time, the provider generally also has certain information that the provider shares (e.g. material cost, feature cost, total bid amount) but also has additional information that the provider does not share (e.g. that a certain material is cheaper and looks the same as the material the customer selected, that discounts are available at different material amount tiers, that certain a la carte features are gratis at a certain material amount threshold, etc.). Again, this information may not be provided for competitive reasons, such as to insure that the provider is not low-balled by the customer or underbid by a competitor, or because the provider simply may not recognize, when providing the bid, that the unshared information would be material or useful to the customer. This in turn may be because the customer has not shared any information which would lead the provider to that conclusion. Again, the problem of information asymmetry and lack of perfect information prevents efficient decision-making, as does the problem of being unable, in the prior art, to compare the quality of work done by two different providers with comparable pricing.

The system works as an aggregator that allows for a customer to select how a project will be performed without the necessitate of either party sharing or exchanging information which each party would prefer not to share or exchange. Specifically, the user can select details of the project in a first attempt to determine what they want. Once they have an idea of the price and availability of this, the system can propose possible modifications to the project they may not have considered but that may give them a better value. Customers may also review the quality of each installer, in side-by-side fashion, based upon prior customer reviews of that installer, including numeric ratings of the installer provided by prior customers, as described elsewhere herein. They can investigate these and determine if this is a modification they would be interested in. If they are, they can make the modifications and further investigate likely quotes for this level of work. This allows the user to take an iterative stepwise process in selecting custom work with multiple possible providers. This is something that has been previously unavailable as stepwise progression generally required negotiation with a single provider (e.g. a provider may offer a particular upgrade or option), but the user was generally unable to compare that upgraded option to the option they had got previously from another provider. Thus, a user can utilize the system to settle on the exact scope of work and materials even if these were unknown or variable at the start, and then obtain the best price for this specific work even if it is from a provider they may not have contacted.

The quote criteria provided by the user may include the use of descriptive hashes and/or search by material. This is a major improvement over existing solutions, as there is currently no simple or fast way for a customer to compare the quotes among providers who can install a given material. For example, if the user has found the type of wood flooring the user wishes to have installed, the user can get bids for all installers who install that specific material. They can also get this information without needing to know who would install that material in their local area, or where the material was available from.

The display (107) may also include feedback or ratings for each installer. In an embodiment, the rating may be a number in a range, such as “3/5,” or may be visually depicted as one or more symbols or tokens or a portion thereof (613). In the depicted embodiment of FIG. 6, ratings are depicted as a number of “stars” (613). These community ratings are provided by other customers who have previously used the provider and provided feedback ratings. Ratings are discussed in more detail elsewhere herein.

One advantage of the systems and methods is that providers may worry less about arithmetic errors, transposed numbers, or other overlooked elements of the bid, all of which can contribute to inaccurate bids that are either too high (costing sales) or too low (costing profits), because the provider has already supplied the information the provider knows in advance will be needed for a bid. Once the customer provides the additional information needed for a specific project, the bid can be automatically or programmatically calculated. This is also appealing to the provider because it removes last minute haggling for “freebies,” which can draw out project timelines and reduce productivity with unprofitable busywork. The customer has the certainty of a documented price and feature set, and the security that the customer was able to competitively shop bids and get the customer's desired mixture of price and quality, without making a decision under pressure with a provider standing in the kitchen. The system also provides the ability for a provider to market, finalize, and accept payment for projects on-line.

It is typical in projects that changes are made, typically because a customer changes his or her mind about an aspect of the project, or because exigent circumstances require a change by the provider. For example, a material may be delayed or available, or a provider may encounter unexpected difficulties that add to price. The systems and methods generally include the ability to edit or modify a quote. Generally, providers may alter or modify quotes accepted by customers if needed, and the quotes are then returned to the customer for re-approval (e.g., such as by e-mailing the modified quote to a customer-provided e-mail address, or by notifying the customer of the change, and the customer may login to a web site, mobile device application, or kiosk to view the modified quote). The customer may then either accept or reject the modified quote. Even after a quote is finally accepted, changes may take place and this process may be repeated. As described below, all change orders are included in a documentation module.

In further embodiments, the systems and methods may comprise alternative or additional steps and features. By way of example and not limitation, the depicted embodiment of FIG. 2 further comprises a documentation module. Once the user selects (211) a winning bid, documentation may be automatically generated to form the contract. This documentation may also be stored (213) in a database (203) so that both the provider and the customer always have access to it for reference. As changes or change orders are made, the changes may be automatically included in and/or uploaded to the documents section of the web site (e.g., a documents tab), allowing customers and/or providers to review and/or approve them, via corresponding changes to the server-side database structure. The use of robust and complete documentation containing the terms of the bid clarifies project scope, reduces arguing, and improves efficiency. Documents which may be tracked include, but are not necessarily limited to: bids, acceptance, change orders, change order acceptance, bid change, material order, service order, material receipt, proof of insurance, proof of bond, proof of certification, business licenses, union papers, project completion certificates, notice of deliverable, acceptance forms, and lien waivers.

In a still further embodiment, the systems and methods may comprise a scheduling module. By way of example and not limitation, in the depicted embodiment of FIG. 2, project work can be scheduled and the job performed (215). Again, this is generally done by the user manipulating a user interface on a device (301) to indicate the user's acceptance of the desired bid. The descriptions of the scheduling phases may be customizable by a user (e.g., a provider), such as to reflect a particular industry or business practices for the specific user. By way of example and not limitation, the phases may include “bid,” “template,” “fabricate,” “install” or “closed.” The user can scan and upload signed documents, including e-signed documents, accepting the estimate and use an interface to schedule a start time or initial consultation time to meet with the provider and conduct an initial inspection. This may be done, for example, through a calendar interface which only permits the provider's available times to be selected for scheduling. The system may track scheduled events through a database (203).

In a still further embodiment, the system comprises a payment processing module (not depicted). Such a module may provide, transmit, and/or display invoices, receipts, and/or a payment gateway and/or processing system. In such an embodiment, payments may be made automatically, such as by providing a payment card or bank account information and authorizing charges and/or deductions to be made according to the schedule and/or time table for the project. By way of example and not limitation, the payment module may be implemented as a shopping cart model. Such a model may facilitate the addition of multiple projects for comparison, allowing users to view multiple bids with a total for the project, and to thereby be provided an estimate of total project cost without having to commit to any one provider or bid, and without having to waste time visiting multiple provider venues and endure multiple sales pitches.

The systems and methods generally comprise a review/rating module. Such a module generally facilitates the submission of numeric ratings, and narrative reviews, of a given provider. These ratings may be provided for a plurality of performance metrics, such as quality, timeliness, professionalism, cleanliness, and intangibles. These metrics may then be aggregated for a provider into numeric ratings, both within a performance metric and across all metrics, and comparably displayed (107) in connection with quotes. This provides customers with more information about suppliers that may fill gaps in pricing. For example, if Supplier A is substantially cheaper than Supplier B, all else being equal, the reviews help customers determine whether Supplier A simply does lower quality work. In addition to numeric ratings, customers may be provided with narrative reviews of a provider by other customers. These reviews are maintained, updated, and provided in real-time, giving users a “live” rating score for each provider.

Additionally, the system may provide to customers, through the web site, the ability to view a provider profile comprising information about the provider, such as the above-mentioned reviews, average bid amount, number of projects, average rating, average project duration, most recent project date, number of bids accepted, and so forth.

In certain embodiments, a long-term hindsight review (221) is included whereby users may submit a review, which may be a second review, only after a certain minimal amount of time has elapsed since the project end date. This minimum may be any appropriate amount of time, but will generally be at least six months and possibly a year or more in certain embodiments. This “hindsight” review feature allows users to live with the completed improvements for some time and discover any flaws, and learn how well the work and materials hold up to wear and tear.

It is common with home improvement that the brand new materials look so much different, and better, than the prior state of the home that the customer is blind to the flaws. By only permitting hindsight reviews after some minimum amount of time has passed, the temporary euphoria of a recently completed project has passed and the customer has more time to get familiar with flaws and deficiencies. Thus, in certain embodiments, the “hindsight” review is comparatively displayed alongside the standard review, allowing users to quickly assess how well a given provider's work stands the test of time. If a certain supplier has high initial ratings but low hindsight ratings, it may suggest that the supplier obscures shoddy work. As with the other modules, hindsight review provides rating and review data (223) to the database. Although the review/rating data (225) is not quote data (201), it is nevertheless one of the datasets generally selected (105) from the database (203) for display (107) to the customer.

In an embodiment, notifications are sent to one or more providers. By way of example and not limitation, where the user selects (211) a winning bid, the system may instruct the user to provide certain additional documents which will allow the provider to finalize the quote/estimate and confirm that it is accurate and acceptable. The system may also notify the provider, for example, by sending an e-mail to a pre-defined e-mail address, that a quote has been accepted so that the provider can follow up with the customer to complete the process. Likewise, when users upload or provide documents (213, 217), the provider can review the documents for completeness and/or accuracy, and may also provide documents back to the user through the system.

An aspect of the systems and methods is that quotes may be provided for all available materials and/or features across all available providers and material suppliers for a particular group. This may be so, even though a particular material supplier and provider may have no relationship, because a given service provider may nevertheless be able to acquire the material through the supplier and use it on the project. By way of example and not limitation, material suppliers may be matched with service providers whether or not a formal relationship exists between the provider and supplier. This includes, for example, where the database content does not comprise an association between a supplier profile and a provider profile.

This feature facilitates, among other things, relationship building between material suppliers and service providers, in that a customer may select a winning provider to install a material provided by a material supplier with which the service provider has not previously worked. This benefits suppliers by expanding the range of providers who are aware of and have experience installing materials supplied by that supplier, and it benefits providers by expanding the range of suppliers with whom the provider has a relationship, and materials the provider has experience installing. This benefit is particularly applicable to foreign suppliers, who may be attempting to break into new geographic territories.

This also benefits the customer in that the combinations of providers, suppliers, and materials may not be limited. By way of example and not limitation, the customer may receive multiple bids for a project using the same material, but different bids may assume that the material is acquired through a plurality of material suppliers. This facilitates an open marketplace where customers are not confined to a limited range of options based on the pre-existing relationships between providers and suppliers.

Another aspect of the systems and methods is the ability to “snapshot” a bid or quote. It is common in projects that scope or other changes may be made. By way of example and not limitation, the initial quote may reveal issues not provided by the customer, or construction may reveal additional problems with the work site that must be addressed. Changes can be made to the quote by the provider, creating a “snapshot” of the set of data records in the database pertaining to and describing the estimate prior to such a change is taken, the snapshot comprising a sufficient copy or subset of such data such that the quote can be reconstructed and displayed prior to the change. This “snapshot” dataset is preserved, allowing a user to view the timeline or history of changes to the project. This feature facilitates simpler dispute resolution by providing uniform historical information to all parties. Any changes, along with the original bid, can be viewed via the web site by the installer and/or customer.

Another aspect of the systems and methods is the ability for an imaging device to capture an impression or image of materials and/or uniquely identify a particular piece of material. The imaging device is typically, but not necessarily, a digital camera. This feature would be used, for example, where the raw material is unique. By way of example and not limitation, while granite countertops are selected by pattern, natural granite is inherently unique, and each raw slab contains distinct patterns, colors, inclusions, and features. Customers purchasing granite countertops typically physically visit a warehouse to inspect a plurality of slabs and pick the specific slab the customer wishes to have fabricated into a counter top. It is specifically contemplated an imaging device may be used to capture an image of the slab and/or a unique identifier for or attached to the slab, such as a serial number, bar code, or QR code. This reduces mix-ups in material selection, which can be very costly and difficult to mitigate. As with other features, the captured data may be supplied to and stored in the database for later retrieval and transmission and/or display to the user and/or a provider.

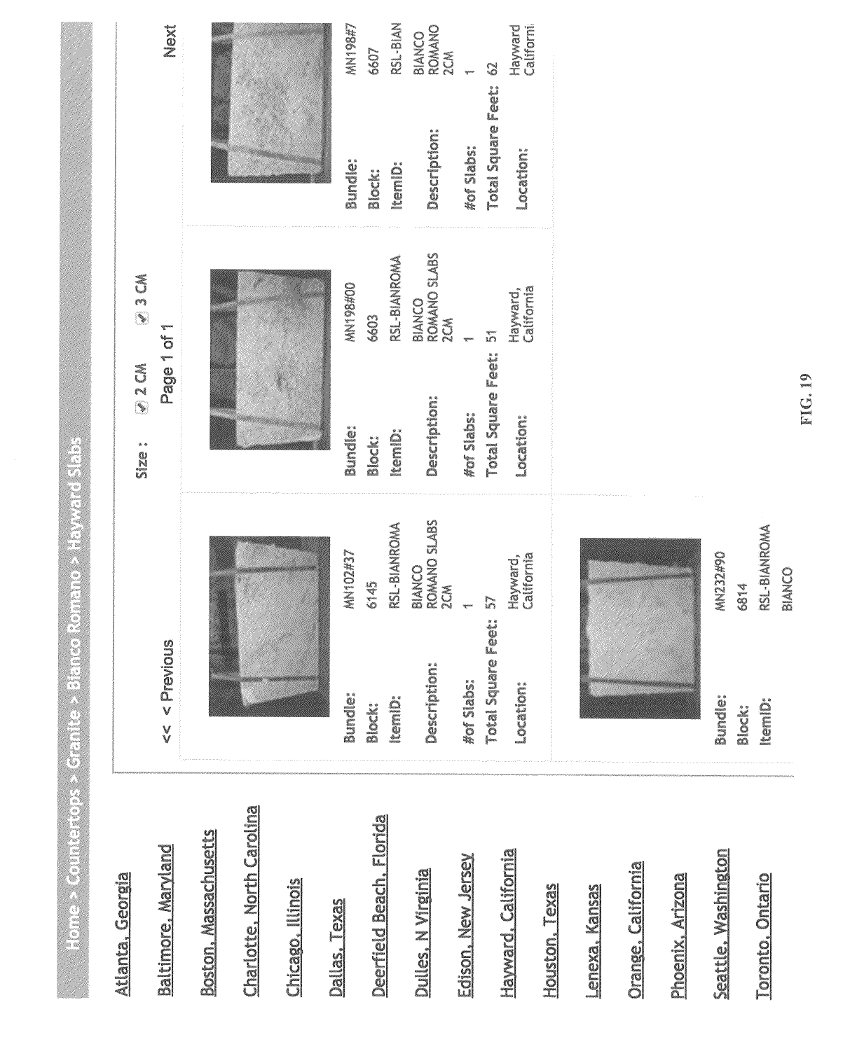

An aspect of the systems and methods may include software for viewing, select, and/or reserve specific raw materials in real-time. This is particularly important in natural or non-fabricated materials, where natural variation in color, texture, and/or pattern may cause certain raw materials to be more or less suitable for a given project. For example, most non-trivial kitchen renovation projects using natural stones require a plurality of slabs of material, because the amount of material needed for the project exceeds the size of a typical slab of stone. To give projects color and pattern uniformity, it is common to use slabs cut from adjacent, or least proximate, areas of the quarry. Slabs of similar material cut too far apart may have minor variations in coloring, tone, or pattern that cause the surfaces, when installed, to appear non-uniform, detracting from the aesthetic appeal of the product. Further, certain slabs may have interesting features, such as atypical coloration or mineral inclusions, which are desirable to some customers but not others. Since each slab is unique, consumers often physically visit a facility to view the available slabs for a given type of stone, and select the specific slabs to be used for the project. Additionally, suppliers may also have records of the dimensions or square footage of slabs. By being able to select a specific slab from the supplier, the customer has the ability to know the exact or approximate square footage of the slab, which may be helpful in calculating price, as the project may run over the size of a slab and require a minimum amount of an additional slab, which can add substantial cost. Where the customer is an installer or provider, knowing the exact slabs also improves the customer's ability to calculate an accurate quote. An embodiment of a user interface for material tagging is depicted in FIG. 19.

In a further embodiment, the system includes a module which optimizes slab selection to minimize waste and maximize slab utilization to keep cost down. By way of example and not limitation, the system may consider the shape, dimensions, and square footage required for the project, and compare those factors to the available slab dimensions/sizes for the selected material, and suggest one or slabs which are best suited (of the available slabs) for the project, and will minimize waste and thus reduce cost. In a further embodiment, the optimization module may suggest alternative materials which are better suited for the project because the available slabs have superior slab optimization properties than the slabs for the material selected by the customer. Such an embodiment may also indicate the price savings that could be achieved by changing materials. By way of example and not limitation, Material A may have only 2 slabs available, each of which is $2,500, and the project requirements may be such that neither slab is sufficient, and the user thus must purchase both slabs, although only a small part of the second slab is needed. However, an alternative material have may a single slab, costing $3,000, of the right size and shape to accommodate the project. The system may optimize the project with respect to the second slab (among others), and suggest that switching materials will save $2,000, because the user will only need to purchase a single $3,000 slab rather than two $2,500 slabs (for a total of $5,000). This also reduces wasted material.

The systems and methods described herein include a software inventory system having images or video, which may be captured and displayed in real-time to the end-user, of one or more slabs available in a slab storage facility (such as, for example, a quarry, fabricator, supplier, stonecutter, or warehouse). In an embodiment, the end-user is shown only those slabs currently in inventory, and not already reserved for another project. The end-user may indicate or select the slab or slabs to be used in the project using the software, saving the user from having to make a trip to physically visit the warehouse. While many users may choose to still physically view the slabs, this system may be used to at least reserve slabs. At the slab storage facility, a computer system may be used to view, display, or otherwise receive information or data concerning the identification of slabs that have been reserved. Employees at the storage facility will thus know not to sell or double-reserve a slab for customers physically visiting the facility. The reservation/tagging system use, incorporate, communicate, integrate, or interoperate with inventory or asset management software for the slab storage facility to reserve slabs.

This tagging/reserving system is not confined to slabs, and can be used with any type of material, though it is particular suitable to materials with natural variation, such as woods and natural stones. It will be apparent to one of ordinary skill in the art that the particular slabs displayed for a given project may depend upon the service provider selected. By way of example and not limitation, if a particular service provider does not work with a particular supplier, then slabs held by that particular supplier may not be available for view in connection with that service provider's bid. In an embodiment, the system displays to the end-user information about the slab available for viewing and/or reserving and/or tagging in connection with a particular bid. By way of example and not limitation, a user may be shown two very different prices for a project, but the lower bid does not include the ability to view/reserve materials. A user may prefer the higher bid and the option to reserve materials in advance.

It will be further understood by one of ordinary skill in the art that when a bid offer is rejected or an alternative is accepted, any slabs reserved for the rejected bid may be un-reserved for selection by other users. In a still further embodiment, users may queue reservations in a priority queue based upon first in time. By way of example and not limitation, where a particular slab is desired by multiple parties, the first in time to reserve the slab has priority. However, a second buyer may also reserve the slab. If the first user then cancels his project or otherwise decides not to use that slab, the second reserver may be automatically promoted to the first reserver, and then have that slab reserved for his project. This in turn may cause the second reserver to automatically release a reservation on another slab. Messages, notifications, or requests for confirmation may be sent in connection with such changes in reservation status.

In certain embodiments, the systems and methods may use, incorporate, communicate, integrate, or interoperate with third party software. By way of example and not limitation, such software may be visualization software. Visualization software will be understood by one of ordinary skill in the art as software providing a computer rendering of the project, typically as three-dimensional model, though two-dimensional products are also known. An example of such visualization software is Renoworks®. A feature of such a system is that the material to be used in the project may be rendered in the visualization software to give the user an indication of what the material will look like in the finished project. This may be done by rendering a photo or image of the user's selected material on the counter surface of the visualization model, such as through use of a projection. This may be particularly useful in conjunction with the material reservation feature described elsewhere herein, as the user could then see the specific material (e.g., stone slab) rendered in the model. In a still further embodiment, the user may select various orientations of the slab and indicate a preferred orientation of the material for cutting. In a still further embodiment, the user may take a photo of his or her project space (e.g., a kitchen), and the applicable surfaces are identified and the user's selected materials are projected onto those surfaces so that the user can see how the material may appear in the user's specific project space. These and other features may be integrated into the systems and methods, such as via an import feature by which project data or criteria provided by the user are automatically provided to the visualization software, saving time and improving accuracy.

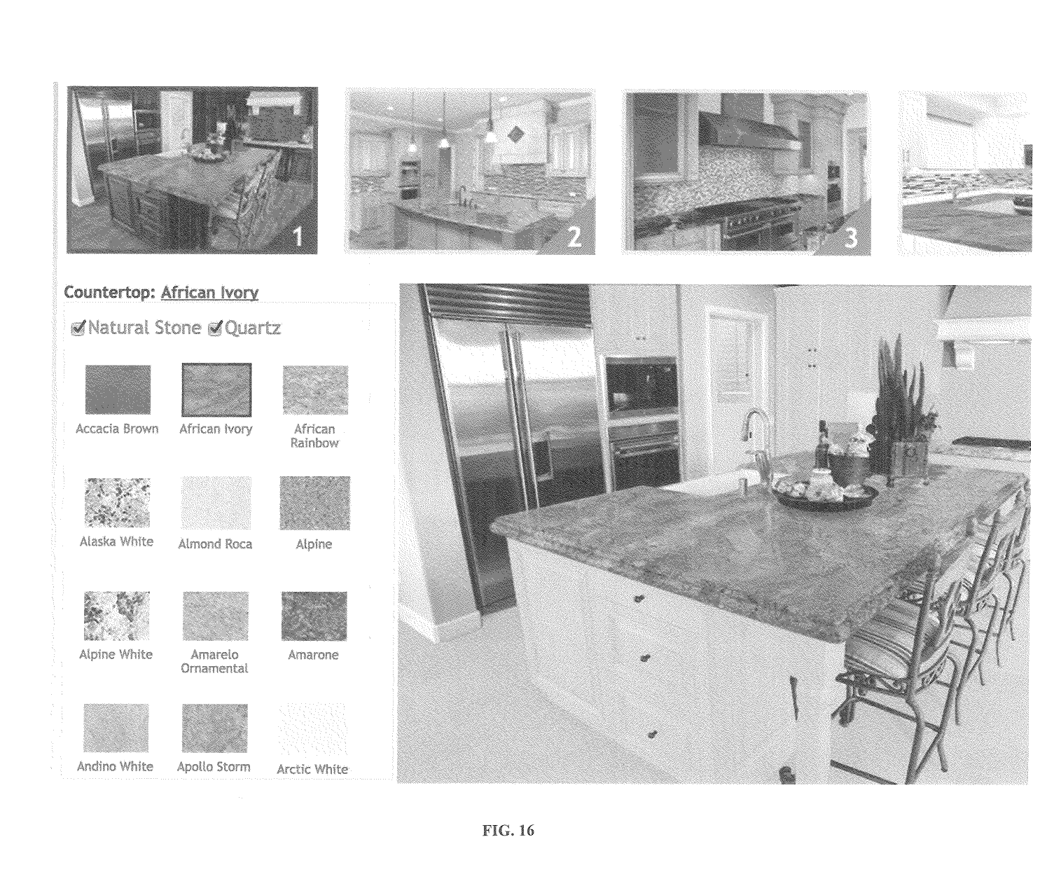

In a still further embodiment, where the user selects a plurality of materials, the user may use such visualization software to render each of the plurality of materials in various configurations and indicate a preferred configuration. For example, two particular granite slabs may have colors or patterns which align well when adjacent, but do not align if either slab is oriented differently. The user may indicate the position and orientation of each slab in the project, which information may then be provided to the service provider and/or fabricator, or other actors in the system. In an embodiment, the systems and methods provide or make available to visualization software data about the project, which data is used by the visualization software to provide to the user a visualization of the proposed project. In an embodiment, this visualization may be displayed and/or interacted with through a web browser. An embodiment of such visualization software is depicted in FIG. 16.

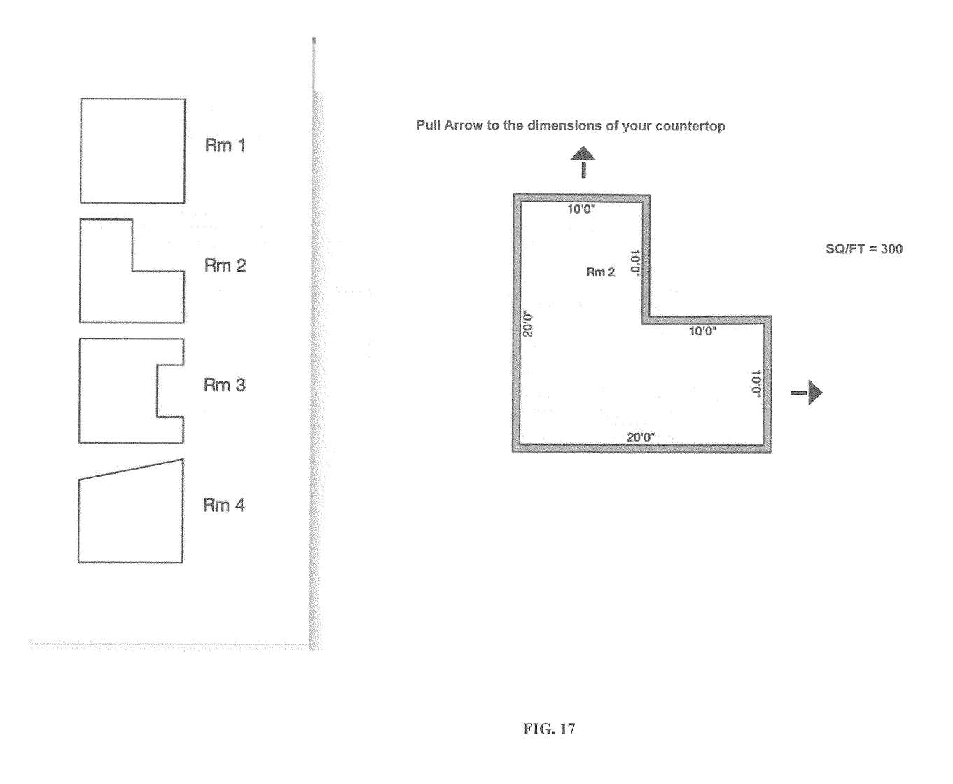

In a further embodiment, the systems and methods include, use, incorporate, communicate, integrate, or interoperate with a square footage calculator. Such calculators typically allow users to select, or indicate, a general kitchen layout, and then calculate the square footage of surface material needed for the project. This provides users the ability to estimate project material requirements without knowing the actual formulae used to calculate it. These tools may allow the users to select from a predefined set of layouts and modify them to match the user's actual dimensions (e.g., by dragging edges), or manually enter layouts and dimensions. Such systems have the advantage of eliminating arithmetic and guesswork from users who may double-count certain surfaces or omit others. For example, whereas one user may include under-counter space in calculating flooring square footage, another may omit it. This can result in misaligned pricing assumptions that cause bids to be accurate. Such inaccuracies will generally be blamed on service providers, or the system itself, which may erode user confidence in the system. By using a calculator, assumptions about what is included/excluded in the figures provided may be reduced or eliminated, and square footage figures provided may be more accurate. This may in turn cause bids to be more accurate. An embodiment of such calculator software is depicted in FIG. 17.

The systems and methods may take into account, including but not limited to through use of such calculators, shipping unit volumes, and calculate the bid estimate based in part on such volumes. It is common that units of materials are shipped in certain pre-packaged volumes and, to the extent a project runs over the shipping volume, an additional order must be placed for at least the minimum amount of material. This can result in surplus material that may not be used on the project, but which the service provider still must procure and pay for. By way of example and not limitation, hardwood flooring slats may be advertised and priced by the square foot, but the smallest shipping unit may be boxes of 20 square feet of material. By way of example and not limitation, if a project requires 205 square feet, then eleven boxes must be purchased, meaning 220 square feet are purchased, even though the project needs only 205. Such surplusage is generally left with the consumer for future repairs/replacements. This again can caused a misalignment in assumptions or expectations between service providers and consumers, which can sour the business relationship and breed distrust. By including such shipping volumes in the bid calculation, the systems and methods give the user access to better and more accurate cost information. The shipping volume data is generally, but not necessarily, provided or set by a supplier, and may vary from supplier to supplier.

In a still further embodiment, the system may increase or inflate the square footage of the project to account for waste. It is typical in many construction industries that as much as 10-40% of raw materials are not directly used in the project because they are discarded as waste. By way of example and not limitation, flooring material may be cut short to fit into a corner or butt against a wall, or may be cut on the diagonal. The cut material may be too small or improperly shaped for further use in the project and is considered waste. Waste is generally expected, but failure to account for waste in bidding is a common mistake. Alternatively, consumers may be inconsistent in whether their square footage includes waste, causing mis-alignment between the consumer and service provider as to what the numbers represent. The systems and methods may increase the volume of material needed to account for such waste. The waste percentage may be predefined, a default value, or custom-set by a particular actor in the system, such as a specific service provider or supplier. This allows service providers, who are generally in the best position to know what their typical waste percentages are, to more accurately reflect price, or the hedge against risk by over-estimating waste. By way of example and not limitation, the instructions for using the web site may instruct the user how to measure square footage, or may use a square footage calculator, and then increase that figure for each individual bidding service provider based upon that service provider's waste percentage for that good.

It should be understood that a service provider may have different waste percentages for different products and features. For example, a service provider may have a 10% waste percentage for tile flooring as opposed to wood flooring, because the service provider knows that tile will shatter more frequently. Alternatively, a given service provider may have a higher waste percentage for a particular type of wood flooring because in the service provider knows that the quality is lower and the wood splinters frequently. Alternatively, the waste percentage may go up where certain features are included. By way of example and not limitation, a tile backsplash may have a 10% waste percentage, but if the user requests “diagonal” or “diamond” orientation as a feature, half of the top row of tile will be wasted to make the cut properly, resulting in substantially increased waste. The service provider thus may provide a 15% waste percentage for that feature.

In a further embodiment, the systems and methods include a shopping cart feature to allow a plurality of service offerings/bid. By way of example and not limitation, the systems and methods may be implemented for various kitchen projects, such as counter tops, cabinetry, flooring, tile, ceilings, doors, lighting, and trim. In a shopping cart embodiment, a user may use the systems and methods to view competing bids for countertop work as specified by the user and select a winning bid. The user may then also use the systems and methods to view competing bids for the flooring work as specified by the user, and select a winning bid. The winning bid for each phase of the project is stored using a shopping cart purchasing model, generally with each winning bid displayed as a line item in the cart. The “winning” bids may be held in the cart, without completing the order and actually finally selecting the bid, until the user checks out via the shopping cart system. In this way, users may bid all phases of the project and arrive at a grand total, and compare and contrast various combinations of service providers and bids, to get a global picture of the project scope and cost, before committing to any particular bid.

In a further embodiment, the systems and methods include, use, incorporate, communicate, integrate, or interoperate with an enterprise resource planning and/or job tracking system. This may be done through direct communication, direct integration, a data export/import procedure, or any other means known or in the future developed in the art. This may be done when the user accepts a given bid, or, alternatively, when a bid is first offered. In the latter case, the bidder then has key job data in the bidder's ERP/job tracking system and can begin to review for accuracy/completeness and provide any special offers, deals, upgrades, or updates to the consumer which may make the bid more attractive. Another advantage of this approach is that data is generally faithfully transferred form the bidding software to the ERP system, reducing human error, such as number transposition. This increases accuracy and reduces administrative overhead.

It is also contemplated that the systems and methods will produce and make available to users, who may be consumer end-users, suppliers, fabricators, or any other user of the system, certain reports based upon the data stored by the system. By way of example and not limitation, such reports may include performance metrics and statistics, progress reports, comparisons to the industry at large, sales metrics, and overall business “report cards” or “health reports.” Such reports may be general or industry-specific, or may be regional or enterprise-specific. This allows business owners to assess whether their pricing, timing, and productivity levels are competitive on a local, regional, or national scale. The metrics reported may vary from industry to industry, but generally comprise financial and operational metrics known in the art, such as profit margins. This addresses yet another problem in the art, which is that it is difficult to get transparent sales data from a plurality of providers in any industry, which in turn makes it even more difficult to provide industry-wide data on an apples-to-apples comparison basis.

The systems and methods may be used in conjunction with a wide variety of projects, materials and features. A non-limiting list of such projects, materials, and features are described herein.

In an embodiment, the systems and methods are used for landscaping services. Such quote metric data may include, without limitation: labor hours and cost, tree/bush trimming, weeding, clean up, removal, blowing, drip and water system installation or repair, planting, trenching, trip charge, service charge, plans, permits, inspections, and tool rental, deposits, or other charges.

In an embodiment, the systems and methods are used for flooring services. Such quote metric data may include, without limitation: installation, labor, type of flooring, molding, base boards, weather stripping, door jams, epoxy, glue for flooring, pad for flooring, foam for flooring, carpet, tile, natural stone, laminate, manufactured flooring, wood flooring, trip charge, service charge, stair charge, rounded stair fee, number of level fee, room fee, wall mount fee, grout fee, no grout fee, # of corners, access fee, installation hours, and waste.

In an embodiment, the systems and methods are used for windows. Such quote metric data may include, without limitation: window size, number of windows, floors of building/home, labor, type of window, type of window sill, access, elevator or no elevator, stairs, scaffolding fee, crane fee, permit fee, inspection fee, number of blades, molding, weather stripping, install fee, trip charge, service charge, type of window material, dual pane or single pane, plans, installation hours.

In an embodiment, the systems and methods are used for window covering services. Such quote metric data may include, without limitation: window size, number of windows, labor, floors of building/home, type of window, type of window sill, access, elevator or no elevator, stairs, scaffolding fee, crane fee, permit fee, inspection fee, molding, type of façade, install fee, trip charge, service charge, type of window covering material, installation hours.

In an embodiment, the systems and methods are used for roofing services. Such quote metric data may include, without limitation: type of roofing, rolled, shingle, tile, flat, foam, install charge, trip charge, permits, inspection, pitch, parapet wall, drainage, emergency charge, repair, seal, removal, crane, plywood, nails, gutters, trusses, plans, materials, waste, generator costs.

In an embodiment, the systems and methods are used for lighting services. Such quote metric data may include, without limitation: installation, labor, trip charge, service charge, removal, electrical repair, outlets, outlet covers, lighting repair, hours to install, wire, materials, bulbs replacement, convert bulb size, dimmer, clap system, digital or Bluetooth setups.

In an embodiment, the systems and methods are used for electrical services. Such quote metric data may include, without limitation: installation, trip charge, service charge, removal, electrical repair, outlets, outlet covers, GFI/GFCI, shorts, pull wire, replace wire, removal, breaker, electric panel repair, electric panel replacement, permits, inspection, plans, access, emergency fee, after hours fee, labor, type of wire, amount of electrical wire, materials, conduit, ground, drilling, tear out, sawing, cutting and replacing concrete, hours to install, dimmers, digital or Bluetooth setups, surround sound wiring, pool wiring, A/C wiring, alarm wiring, generator.

In an embodiment, the systems and methods are used for plumbing services. Such quote metric data may include, without limitation: installation, plans trip charge, service charge, removal, materials, labor, type of plumbing, removal, renovation, new install, dig, camera inspection, glue, type of pipe, elbows, extensions, connections, access, emergency, after hours, indoor/outdoor, weather repair, root repair, snake, drain, number of stories, type of building, location, septic, # of hours to install, generator.

In an embodiment, the systems and methods are used for facades. Such quote metric data may include, without limitation: installation, trip charge, service charge, removal, materials, labor, after hours, number of stories, type of building, location, access, elevator or no elevator, stairs, scaffolding fee, crane fee, permit fee, inspection fee, if it faces the street or not, type of façade, type of renovation, new façade, partial renovation, type of materials, generator.

In an embodiment, the systems and methods are used for pool services. Such quote metric data may include, without limitation: installation, trip charge, service charge, removal, materials, labor, after hours, plumbing, electrical, equipment, dig out, permit fee, inspection fee, plans, concrete, rebar, water feature, lighting, fiber optics, type of spa, rounded, squared, decking, salt cell, pumps, heater, solar, cleaners, in floor cleaners, skimmer, distance from equipment to skimmer, electric panel, remotes, TVs, spillways, refrigerators, outdoor BBQ, fire pit, stairs, seating, grotto, aerators, time to city, size of pool, access to backyard, wall removal and replacement, generator.

In an embodiment, the systems and methods are used for glass services. Such quote metric data may include, without limitation: installation, labor, materials, trip charge, size, thickness, type of glass, seam pieces, molding, glue, fixtures, supports, framing, hours to install, tax.

In an embodiment, the systems and methods are used for kitchen remodeling services. Such quote metric data may include, without limitation: appliances, drywall, paint, texture, labor, flooring, wall covering, materials, countertops, cabinets, sinks, fixtures, lighting, skylights, permits, inspections, plans, plumbing, electrical, hours to install, tax, generator.

In an embodiment, the systems and methods are used for bathroom remodeling services. Such quote metric data may include, without limitation: installation, toilet, shower, urinal, bidet, plumbing, electrical, drywall, paint, texture, labor, flooring, wall covering, materials, fixture, mirrors, cabinetry, tub, steamer, sauna, spa, hours to install, number of rooms, number of corners, tax, generator.

In an embodiment, the systems and methods are used for countertop services. Such quote metric data may include, without limitation: amount of material, type of product, labor, fabrication, installation, trip charge, number of under-mount sink cutout, number of top-mount sink cutouts, number of cooktop cutout, number of radii, number of upgraded edges, amount of backsplash, number of outlet cutouts, amount of countertop removal, number of rooms, amount of standard edge, number of steel support, amount of refinish, leveling, amount of plywood, number of slabs, change scope, amount of overhang, templating, digital layout, seam charge, digital seam lay, 20/20 drawings, hand drawings or CAD drawings, measurements, special order charge, sink charge, faucet charge, clean up charge, tax.

In an embodiment, the systems and methods are used for sink installation services. Such quote metric data may include, without limitation: type of sink, number of sinks, labor, materials, installation, seals, cutouts, plumbing, trip charge, service charge, tax, molding, type of faucet, number of man hours.

In an embodiment, the systems and methods are used for fixture installation services. Such quote metric data may include, without limitation: labor, materials, installation, seals, trip charge, service charge, support installation, hanging, electrical, removal, staining, resurfacing, painting, refurbishing, hours to install, tax.

In an embodiment, the systems and methods are used for concrete services. Such quote metric data may include, without limitation: yards of concrete, labor, number of cement bags, man hours, number of concrete truck hours, crane, hand mixer, machine mixer, tools, waste, square feet to pour, tax, generator.

In an embodiment, the systems and methods are used for block wall installation services. Such quote metric data may include, without limitation: yards of concrete, labor, number of blocks, number of cement bags, man hours, number of concrete truck hours, crane, hand mixer, machine mixer, tools, waste, supports, metal posts, trenching, flattening, compressing the ground, machinery (such as, for example, a Bobcat™), height of wall, painting, cleaning, refinishing, repair, tax.

In an embodiment, the systems and methods are used for fence installation services. Such quote metric data may include, without limitation: type of fencing, linear feet/inches, height of fence, weight of fence, support, material, labor, installation, hours to install, trenching, digging, flattening, compressing the ground, equipment rental (such as, for example, a power auger), height of wall, trucking cost, painting, sanding, cleaning, refinishing, repair, tax.

In an embodiment, the systems and methods are used for outdoor flooring services. Such quote metric data may include, without limitation: Astroturf™, rolls quantity, type of natural stone, type of manufactured stone or other manufactured outdoor surfaces, thickness of stone, dimensions of slab, transport, size of grout line, type of grout, type of sealers, number of sealers, concrete, amount of concrete tile, leveling, outdoor carpet, number of yards, labor, materials, installation, trip charge, service charge, refurbish, clean, square feet, tax.

In an embodiment, the systems and methods are used for door installation services. Such quote metric data may include, without limitation: number of doors, type of doors, removal, repair, replacement, size of door, type of access, door fittings, moldings, materials, adjustment, special order fee, trip charge, service charge, tax, man hours, type of door knob, replacement of door knob, swap door knob to new door.

In an embodiment, the systems and methods are used for drywall services. Such quote metric data may include, without limitation: number of plywood sheets, labor, materials, man hours, nails, glue, tape, texture, epoxy, trip charge, service charge, delivery charge, tax.

In an embodiment, the systems and methods are used for framing services. Such quote metric data may include, without limitation: materials, labor, installation, nails, glue, electricity, plans, inspection, permits, trip charge, generator, crane, scaffolding, support beams, wiring holes, arches, parapet walls, pony walls, truss framing, window framing, door framing.

In an embodiment, the systems and methods are used for interior texturing services. Such quote metric data may include, without limitation: labor, materials, man hours, tape, trip charge, bags of texture, square feet to texture, type of texture, generator, machine use/depreciation, color.

In an embodiment, the systems and methods are used for painting services. Such quote metric data may include, without limitation: labor, materials, man hours, tape, trip charge, plastic, paint sprayer, brushes, type of paint, sealer, primer, square feet to paint, height of ceiling, number of tones, rollers, machine use/depreciation, color, tax

In an embodiment, the systems and methods are used for water and mold remediation services. Such quote metric data may include, without limitation: tear out, removal, fungicide, anti-mold growth treatment, fans, dehumidifier, man hours, trash container, trip charge, emergency service charge, normal service charge, distance, pump, generator, license, certifications required, hazardous material protection and disposal, testing, scraping.

In an embodiment, the systems and methods are used for cabinetry services. Such quote metric data may include, without limitation: type of cabinets, size of cabinet, number of cabinets, molding, spacers, lazy susan, wine rack, hardware, closing features, face type, replacement, refinishing, staining, refurbish, leveling, template, design, specialty cabinet, finishing, electrical, lighting, nails, glue, plywood, wonder board, base boards, overhang, island, bar, crown molding.

In an embodiment, the systems and methods are used for general building/remodeling services. Such quote metric data may include, without limitation: plumbing, electrical, permits, inspection, trip charge, removal, labor, materials, drywall, paint, texture, tape, roofing, framing, concrete, lighting, kitchen, bathroom, patio, deck, flooring, block wall, fencing, sinks, chimney, gutters, pools, spa, heating, cooling, alarm, doors, molding, caulk, closets, mirrors, molding, windows, window covering, removal, odor removal, locks, hours to install, tax, square feet/yards, man hours, machinery usage, framing, supports, glass, countertops, pool façade, landscape, fixtures, outside flooring, weather stripping, A/C repair, A/C installation, steel work, stucco, crane, scaffolding, # of stories, distance, insurance, depreciation of equipment, plans, engineer, drafter, planner hours, waste, vehicle, license, bond, workers comp, vanities, ceilings, of rooms, stairs, banisters, columns, vanities, appliances, glue, fixtures, skylights, bidet, tub, steamer, sauna, spa, staining, resurfacing, trenching, generator, water/mold remediation.

In an embodiment, the systems and methods are used for screen printing services. Such quote metric data may include, without limitation: size of print, type of print, type of machinery needed or used, type of ink, type of drying method, type of materials printed upon, cost of materials, size of materials, set-up costs, art costs, design costs, creating vector-format, creating CKM format, RGB printing, flocking, man-hours, time to complete job, washing, dye lot.

While the systems and methods have generally been described above with reference to end-user devices such as a web browser viewing a web site or a mobile device application, it should be noted that the systems and methods may be implemented via a standalone kiosk. In such an embodiment, the systems and methods generally operate according to the principles described herein, with such minor variations appropriate for implementation via a kiosk, such as touch-screen interface controls and changes to screen resolution/dimension, and a full-screen operational mode (as opposed to a web browser view). It is specifically contemplated that the same set of quote metric data may be used for both conventional devices and kiosks, with the system making automatic adjustments for each. Further, where kiosks are supported, providers and other commercial users may “preview” kiosk screens to understand the customer experience with a kiosk-based system, and the user may able to provide kiosk-specific information to improve the kiosk experience. By way of example and not limitation, users may be able to provide custom welcome or splash screens, custom welcome messages, custom multimedia, and the kiosks may also be able to accept payment, such as through a payment card reader or automated integration with an in-store payment system. By way of example and not limitation, a kiosk system in a big box retail store may allow customers to pay for their projects by charging the costs to the retail store's charge/credit account.

The systems and methods, in particular but limited to the kiosk implementation, can function as a replacement for the sales agent. They eliminate the need for a human agent to safeguard confidential pricing information and to perform complex calculations, and provide an additional customer sales tool. The systems and methods visually display to users instant pricing estimates for all available materials through any available supplier chain, including installation costs and feature cost comparison. This is an improvement over prior art systems, which cannot handle the complex and variable calculations needed to provide side-by-side quote comparison for each permutation of material, supplier, provider, and so forth. Prior art systems also lack the instant system's ability to provide customer self-service, which lowers costs and eliminates the need to filter customers through sales staff.

In an embodiment, co-browsing or co-chatting technology may be implemented whereby a customer service agent or representative may assist a user or customer with using the web site. Such technologies may allow the customer service agent to manipulate the user interface, such as to demonstrate use and features. This may be done in any type of embodiment, whether a web site implementation, full-screen kiosk, standalone app or application, and so forth.

While the invention has been disclosed in connection with certain preferred embodiments, this should not be taken as a limitation to all of the provided details. Modifications and variations of the described embodiments may be made without departing from the spirit and scope of the invention, and other embodiments should be understood to be encompassed in the present disclosure as would be understood by those of ordinary skill in the art.

1. A method for comparatively displaying quotes comprising:
providing a database;
providing a quote server communicatively connected to an end-user client device over a telecommunications network and communicatively connected to said database, said quote server comprising a microprocessor operatively coupled to a non-volatile computer-readable storage medium having computer-readable instructions stored thereon, said computer-readable instructions comprising a quote module;
storing normalized quote metric data in said database, said normalized quote metric data comprising a plurality of material pricing tiers for a material, each material pricing tier in said plurality of material pricing tiers having a material quantity range to which the pricing tier applies and a material price for said material, said material price associated with said material quantity range;
said quote server receiving from said end-user client device over said telecommunications network a customer project criteria dataset comprising an indication of an amount of material to be used in said customer project and an indication that said material is to be used in said customer project;
in real time after said receiving step, said quote module selecting from said stored normalized quote metric data a search result dataset, the selection of said search result database being based at least in part on said received customer project criteria dataset and said search result comprising data indicative of a plurality of service providers, each service provider in said plurality of service providers being associated in said stored normalized quote metric data with said material;
in real time after said selecting step, for each one of said service providers in said plurality of service providers, said quote module calculating a bid estimate for said service provider to install said material in said customer project, said calculated bid estimate being calculated in part based on said plurality of material pricing tiers, and said calculated bid estimate being based at least in part on said indication of an amount of material received by said quote server;
in real time after said calculating step, said quote server transmitting data to said client device, said transmitted data enabling to be displayed on said client device, for each one of said service providers in said plurality of service providers, an identification of said service provider indicated in said stored normalized dataset and said calculated bid estimate for said service provider.

2. The method of claim 1, wherein said indication of an amount of material is an area.

3. The method of claim 1, wherein said indication of an amount of material is a plurality of dimensions usable to calculate an area.

4. The method of claim 1, wherein for each calculated bid estimate for said selected plurality of service providers, said calculated bid estimate is calculated in part by identifying in said plurality of material pricing tiers a material pricing tier having a material quantity range corresponding to said received indication of a material amount, and multiplying said material pricing amount associated with said identified material quantity range by said indication of an amount of material.

5. The method of claim 4, wherein:
said customer project criteria dataset further comprises an indication of a feature to be included in said customer project and an indication of a quantity of said feature to be included in said customer project; and
said normalized quote metric data stored in said database further comprising a plurality of feature pricing tiers for a feature, each feature pricing tier in said plurality of feature pricing tiers having a material quantity range to which said feature pricing tier applies and a feature pricing amount associated with said material quantity range;
in said selecting step, each service provider in said plurality of service providers being associated in said stored normalized quote metric data with said feature;
in said calculating step, for each calculated bid estimate for said selected plurality of service providers, said calculated bid estimate is calculated in part by identifying in said plurality of feature pricing tiers said material quantity range corresponding to said indication of an material amount and multiplying said feature pricing amount associated with said identified material quantity range by said indication of a quantity of said features.

6. The method of claim 5, wherein:
each material pricing tier in said plurality of material pricing tiers for a material further comprises a feature quantity range for said indicated feature to which said material pricing tier applies and a material pricing amount associated with said feature quantity range for indicated said feature;
in said calculating step, for each calculated bid estimate for said selected plurality of service providers, said calculated bid estimate is calculated in part by identifying in said plurality of material pricing tiers said feature quantity range corresponding to said indicated quantity of said feature to be included in said customer project and multiplying said material pricing amount associated with said identified feature quantity range by said indication of a quantity of said material.

7. The method of claim 1, wherein for one of said material pricing tiers, said material quantity range is less than or equal to a threshold amount.

8. The method of claim 1, wherein for one of said material pricing tiers, said material quantity range is equal to or greater than a threshold amount.

9. The method of claim 1, wherein for one of said material pricing tiers, said material quantity range is between two threshold amounts.

10. The method of claim 1, wherein said material is a fabricated stone.

11. The method of claim 1, wherein said material is a natural stone.

12. The method of claim 11, wherein said material is granite.
